(19) United States
(12) Patent Application Publication
(10) Pub. No.: US 2016/0350853 A1
(43) Pub. Date: Dec. 1, 2016

(54) MONEY CALENDAR

(71) Applicant: TomsTradingRoom, LLC, Lakewood Ranch, FL (US)

(72) Inventor: Tom GENTILE, Lakewood Ranch, FL (US)

(73) Assignee: TomsTradingRoom, LLC, Lakewood Ranch, FL (US)

(21) Appl. No.: 15/165,998

(22) Filed: May 26, 2016

Related U.S. Application Data
(60) Provisional application No. 62/166,529, filed on May 26, 2015.

(51) Int. Cl. G06Q 40/04; G06Q 10/10

(52) U.S. Cl. CPC G06Q 40/04; G06Q 10/1097

(57) ABSTRACT

A method of displaying patterns in historic stock price data on a graphical user interface includes simulating a plurality of sets of simulated trades for a stock. Each set includes a plurality of simulated trades extending for a common duration between simulated purchase and sale of the stock. Based on historical pricing information for the stock, the method includes determining a profit or loss that would have occurred if the simulated trade had been made. The method includes determining a fraction of simulated trades within each set that would have yielded a profit if the simulated trades had been made, and displaying a graphical representation of each set of simulated trades for which the fraction exceeds a predetermined minimum fraction, the graphical representation including a representation of the common start date and common duration corresponding to each set of simulated trades.

### CROSS-REFERENCE

This application claims priority from U.S. Provisional Patent Application Ser. No. 62/166,529, filed May 26, 2015, all of which is hereby incorporated by reference.

### FIELD

This disclosure relates to systems, methods, and software for visual representation and analysis of data. More specifically, the disclosed embodiments relate to visual representations of stock price data for visual identification of seasonal effects in the historic record of stock prices.

### INTRODUCTION

Stock prices change every day as the result of various market forces. At the most basic level, share prices change according to supply and demand. The supply of a particular stock is determined by the number of people willing to sell the stock at a given price and the amount of that stock held by such people. The demand for a particular stock is determined by the number of people seeking to buy the stock at a given price and the amount of that stock those people desire. If the supply is greater than the demand, the price of the stock drops. If the supply is less than the demand, the price of the stock rises.

The reasons why people desire to own or sell a stock in a company are complicated and likely unknowable. However, various factors are known to affect the price of stocks, including the value of the company, the expected growth of the company, and the projected earnings of the company among many others.

Some stock prices display a cyclical behavior in which the price of the stock oscillates up and down on a particular time scale. The price may not be strictly oscillatory with a definite repeating pattern, but may have a general trend of moving up and back down over a specific period of time.

A special case of this cyclical behavior is called “seasonality.” A seasonal effect is one that occurs over the time scale of one calendar year. For example, a company that sells Halloween costumes may sell considerably more product in the time leading up to October 31st. This increase in sales may occur every year, and the company may be perceived to be more valuable at this time of the year. In general, a seasonal effect may be an increase or a decrease in the price of a stock that occurs every year at a given time during the year. The duration of the increase or decrease may be any length of time less than one year.

The ability to identify seasonal effects in the history of the price for a particular stock or stocks would be a significant advantage to an investor. The same advantages would apply to other financial instruments exhibiting seasonal or cyclical fluctuations in value, such as securities other than stocks (e.g., bonds), futures, foreign exchange rates, and the like.

### SUMMARY

A method of displaying seasonal effects in historic stock price data using a processing device includes receiving, with the processing device, information sufficient to identify a stock. The method further includes retrieving, with the processing device, historical pricing information for the stock. The method includes constructing, with the processing device, a plurality of historic hypothetical trades of the stock including a plurality of common-day trades. Each common-day trade contains a number of individual trades, with each individual trade occurring during a previous year of a predetermined number of previous years. Each individual trade within a common-day trade is characterized by: (a) a common start business day of the year within a start range of business days, (b) a common end business day of the year a predetermined number of business days after the common start business day, and (c) a common designation as either a long trade or a short trade. Based on the historical pricing information for the stock, the method includes determining, with the processing device for each of the plurality of common-day trades, a number of profitable individual trades within each common-day trade, wherein each of the profitable individual trades would have yielded a profit had it been made. For each common-day trade, the method includes creating, with the processing device, an entry on a list of profitable common-day trades if a ratio of the number of profitable individual trades within a common-day trade to the predetermined number of previous years is above a specified accuracy threshold. The entry includes (a) the common start business day of the year for the individual trades within the common-day trade, (b) the common end business day of the year for the individual trades within the common-day trade, and (c) the common designation of the individual trades within the common-day trade as either a long trade or a short trade. The method includes generating, with the processing device, a display of profitable trades including a bar for every entry on the list of profitable common-day trades. Each bar has (a) a first end disposed on the display to indicate the common start business day of the year for the individual trades within the common-day trade, (b) a second end disposed on the display to indicate the common end business day of the year for the individual trades within the common-day trade, and (c) a non-alphanumeric visual indication of the common designation of the individual trades within the common-day trade as either a long trade or a short trade.

A method of displaying patterns in historic stock price data using a processing device, includes receiving, at the processing device, information sufficient to identify a stock and receiving, at the processing device, historical pricing information for the stock. The method further includes simulating, with the processing device, a plurality of historic hypothetical common-day trades for the stock with each common-day trade including a number of individual trades. Each individual trade occurs during a particular previous year chosen from a predetermined number of previous years, and each individual trade characterized by: (a) a common start business day of the year within a start range of business days, (b) a common end business day occurring a predetermined number of business days after the common start business day, and (c) a common designation as either a long trade or a short trade. Based on the historical pricing information for the stock, the method includes determining, with the processing device, for each of the plurality of common-day trades, a number of profitable individual trades within each common-day trade, wherein each of the profitable individual trades would have yielded a profit had it been made. The method includes determining, with the processing device, for each of the plurality of common-day trades, a ratio of the number of profitable individual trades to the predetermined number of previous years. The method further includes, for each common-day trade for which the ratio of the number of profitable individual trades to the predetermined number of previous years is above a threshold ratio, displaying, on a graphical user interface, a graphical representation of the profitable common-day trades. The graphical representation includes a graphical bar representing each profitable common-day trade, wherein for each graphical bar: (a) a first end of the graphical bar represents the common start business day of the year for the individual trades within the common-day trade, and (b) a second end of the bar represents the common end business day of the year for the individual trades within the common-day trade.

A method of displaying patterns in historic stock price data on a graphical user interface includes simulating, with a processing device, a plurality of sets of simulated trades for a stock. Each set includes a plurality of simulated trades and each trade within a set starts on a common start date during a different past calendar year and extends for a common duration between simulated purchase and sale of the stock. Based on historical pricing information for the stock, the method includes determining, with the processing device, a profit or loss that would have occurred if the simulated trade had been made. The method includes determining, with the processing device, a fraction of simulated trades within each set of simulated trades that would have yielded a profit if the simulated trades had been made. The method includes displaying, on a graphical user interface, a graphical representation of each set of simulated trades for which the fraction of simulated trades that would have yielded a profit exceeds a predetermined minimum fraction, the graphical representation including a representation of the common start date and common duration corresponding to each set of simulated trades.

The present disclosure proves a computer-implemented method of identifying and displaying seasonal effects in the price of a financial instrument such as, for example, a stock or a bond. In some embodiments, displaying seasonal effects may include displaying a list of simulated profitable trades in a Gantt-style chart. Features, functions, and advantages may be achieved independently in various embodiments of the present disclosure, or may be combined in yet other embodiments, further details of which can be seen with reference to the following description and drawings.

### BRIEF DESCRIPTION OF DRAWINGS

FIG. 1 is a flow chart depicting exemplary operations performed by a processing device for displaying seasonal effects in historic stock price data, according to aspects of the present teachings.

FIG. 2 is an exemplary display of results of historic stock price data analysis for use in visual identification of seasonal effects, according to aspects of the present teachings.

FIG. 3 is a screenshot depicting an embodiment of a main menu displayed on a graphical user interface of a computing device, according to aspects of the present teachings.

FIG. 4 is a screenshot depicting an embodiment of a parameter selection tool of a money calendar tool displayed on a graphical user interface of a computing device, according to aspects of the present teachings.

FIG. 5 is a screenshot depicting an embodiment of a result display tool of the money calendar tool displayed on a graphical user interface of a computing device, according to aspects of the present teachings.

FIG. 6 is a screenshot depicting an embodiment of a trade detail display of the money calendar tool displayed on a graphical user interface of a computing device, according to aspects of the present teachings.

FIG. 7 is a screenshot depicting an embodiment of a mobile money calendar tool displayed on a graphical user interface of a computing device, according to aspects of the present teachings.

FIG. 8 is a screenshot depicting another view of the mobile money calendar tool of FIG. 7 displayed on a graphical user interface of a computing device, according to aspects of the present teachings.

FIG. 9 is a screenshot depicting an embodiment of a mobile details tool of the mobile money calendar tool displayed on a graphical user interface of a computing device, according to aspects of the present teachings.

FIG. 10 is a screenshot depicting an embodiment of a mobile yearly results graph of the mobile money calendar tool displayed on a graphical user interface of a computing device, according to aspects of the present teachings.

FIG. 11 is a screenshot depicting an embodiment of a monthly calendar of an all-market money calendar tool displayed on a graphical user interface of a computing device, according to aspects of the present teachings.

FIG. 12 is a screenshot depicting an embodiment of a daily summary table of the all-market money calendar tool displayed on a graphical user interface of a computing device, according to aspects of the present teachings.

FIG. 13 is a screenshot depicting an embodiment of a trade detail tool of the all-market money calendar tool displayed on a graphical user interface of a computing device, according to aspects of the present teachings.

FIG. 14 is a schematic diagram of various components of an illustrative data processing system.

FIG. 15 is a schematic representation of an illustrative computer network system.

### DESCRIPTION

### Overview

Various embodiments of a money calendar system configured to display seasonal effects in historic stock price data are described below and illustrated in the associated drawings. Unless otherwise specified, the money calendar system and/or its various components may, but are not required to, contain at least one of the structure, components, functionality, and/or variations described, illustrated, and/or incorporated herein. Furthermore, the structures, components, functionalities, and/or variations described, illustrated, and/or incorporated herein in connection with the present teachings may, but are not required to, be included in other data visualization systems. The following description of various embodiments is merely exemplary in nature and is in no way intended to limit the disclosure, its application, or uses. Additionally, the advantages provided by the embodiments, as described below, are illustrative in nature and not all embodiments provide the same advantages or the same degree of advantages.

Aspects of the money calendar system may be embodied as a computer method, computer system, or computer program product. Accordingly, aspects of the money calendar system may take the form of an entirely hardware embodiment, an entirely software embodiment (including firmware, resident software, micro-code, and the like), or an embodiment combining software and hardware aspects, all of which may generally be referred to herein as a “circuit,” “module,” or “system.” Furthermore, aspects of the money calendar system may take the form of a computer program product embodied in a computer-readable medium (or media) having computer-readable program code/instructions embodied thereon.

Any combination of computer-readable media may be utilized. Computer-readable media can be a computer-readable signal medium and/or a computer-readable storage medium. A computer-readable storage medium may include an electronic, magnetic, optical, electromagnetic, infrared, and/or semiconductor system, apparatus, or device, or any suitable combination of these. More specific examples of a computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, and/or any suitable combination of these and/or the like. In the context of this disclosure, a computer-readable storage medium may include any suitable tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, and/or any suitable combination thereof. A computer-readable signal medium may include any computer-readable medium that is not a computer-readable storage medium and that is capable of communicating, propagating, or transporting a program for use by or in connection with an instruction execution system, apparatus, or device.

Program code embodied on a computer-readable medium may be transmitted using any appropriate medium, including but not limited to wireless, wireline, optical fiber cable, RF, and/or the like, and/or any suitable combination of these.

Computer program code for carrying out operations for aspects of the money calendar system may be written in one or any combination of programming languages, including an object-oriented programming language such as Java, Smalltalk, C++, and/or the like, and conventional procedural programming languages, such as the C programming language. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), and/or the connection may be made to an external computer (for example, through the Internet using an Internet Service Provider).

Aspects of money calendar system are described below with reference to flowchart illustrations and/or block diagrams of methods, apparatuses, systems, and/or computer program products. Each block and/or combination of blocks in a flowchart and/or block diagram may be implemented by computer program instructions. The computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer-readable medium that can direct a computer, other programmable data processing apparatus, and/or other device to function in a particular manner, such that the instructions stored in the computer-readable medium produce an article of manufacture including instructions which implement the function/act specified in the flowchart and/or block diagram block or blocks.

The computer program instructions can also be loaded onto a computer, other programmable data processing apparatus, and/or other device to cause a series of operational steps to be performed on the device to produce a computer-implemented process such that the instructions which execute on the computer or other programmable apparatus provide processes for implementing the functions/acts specified in the flowchart and/or block diagram block or blocks.

Any flowchart and/or block diagram in the drawings is intended to illustrate the architecture, functionality, and/or operation of possible implementations of systems, methods, and computer program products according to aspects of money calendar system. In this regard, each block may represent a module, segment, or portion of code, which comprises one or more executable instructions for implementing the specified logical function(s). In some implementations, the functions noted in the block may occur out of the order noted in the drawings. For example, two blocks shown in succession may, in fact, be executed substantially concurrently, or the blocks may sometimes be executed in the reverse order, depending upon the functionality involved. Each block and/or combination of blocks may be implemented by special purpose hardware-based systems (or combinations of special purpose hardware and computer instructions) that perform the specified functions or acts.

### Definitions

“Business day” refers to a normal working day: Monday to Friday, except on holidays. Business days are days during which the public trading of financial instruments such as stocks occurs. Business days are ordered, beginning with the first business day of the calendar year.

A “long trade” is referred to herein as a trade where an amount of a particular financial instrument is bought at opening on a first business day of the year (not necessarily the first business day of the year) and that same amount of the financial instrument is sold at closing on a second business day of the year, with the second business day after or the same as the first business day.

A “short trade” is referred to herein as a trade where an amount of a particular financial instrument is sold at opening on a first business day of the year and that same amount of the financial instrument is bought at closing on a second business day of the year, with the second business day after or the same as the first business day.

### EXAMPLES, COMPONENTS, AND ALTERNATIVES

The following sections describe selected aspects of exemplary money calendar systems as well as related systems and/or methods. The examples in these sections are intended for illustration and should not be interpreted as limiting the entire scope of the present disclosure. Each section may include one or more distinct inventions, and/or contextual or related information, function, and/or structure.

### Example 1

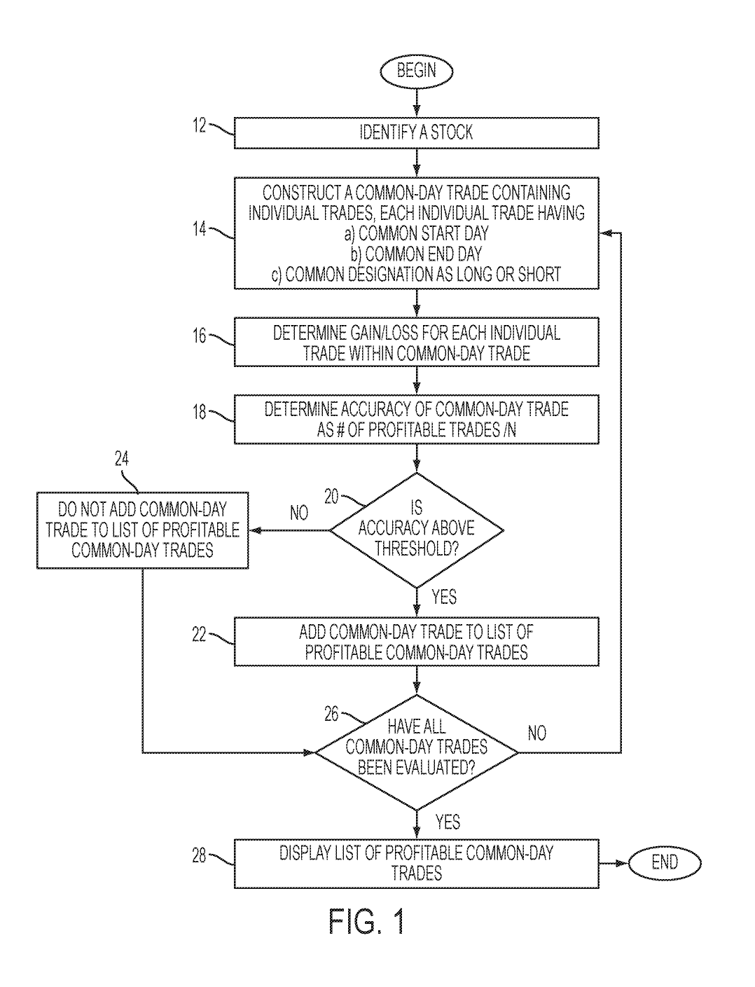

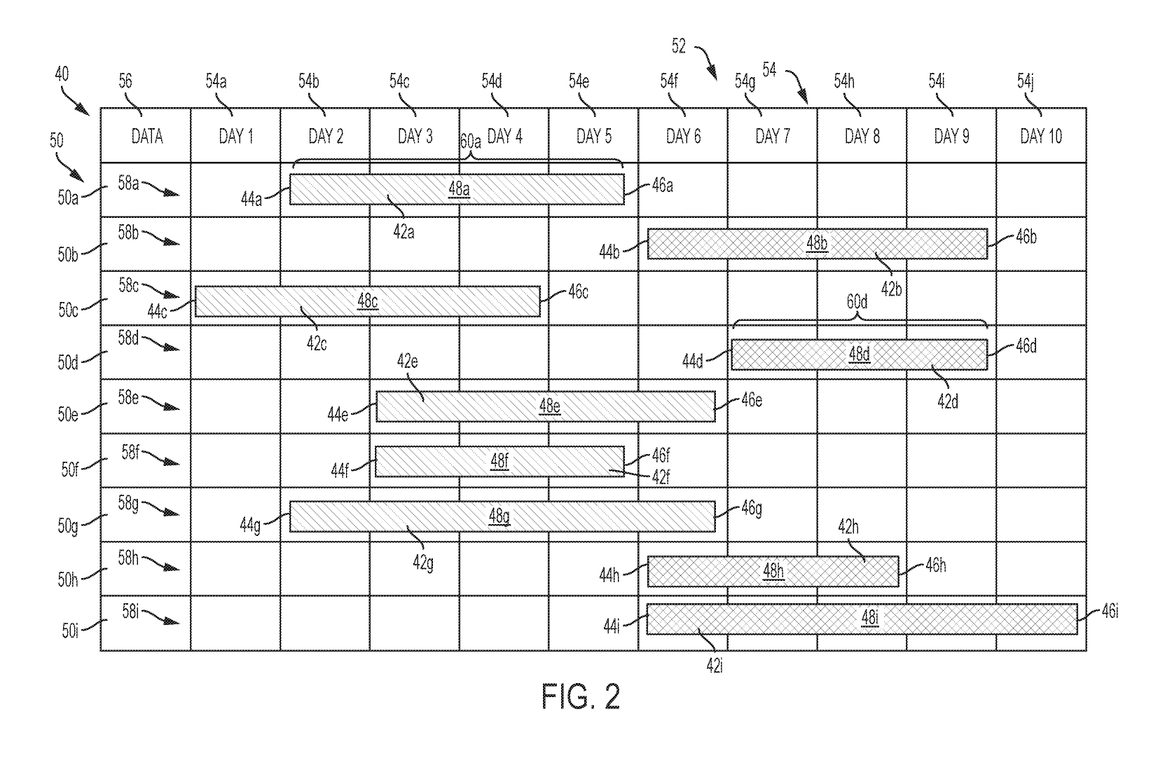

The following example describes a method displaying seasonal effects and/or patterns in historic stock price data, see FIGS. 1 and 2. The method may be performed by a processing device and/or a computer program product. Although this example refers to stock trading, the methods described may be applied more generally to any publicly traded financial instrument.

FIG. 1 is an illustration of operations, generally indicated at 10, which may be performed by a processing device as part of a method of displaying seasonal effects and/or patterns in historic stock price data.

Operations 10 may include a step 12 of identifying a stock. In the case where step 12 is performed by a processing device, identifying a stock may include receiving, by the processing device, information sufficient to identify a stock. In some examples, the stock may be identified by a person or a user, while in other examples, the stock may be identified by the processing device. In some examples the stock may be from a list of stocks and identifying the stock may include proceeding forward or backward through the list from one stock to another.

Once the stock has been identified, operations 10 may optionally include retrieving, by the processing device, historical pricing information for the stock. The historic pricing information may include the price at which the stock was traded at a plurality of times on a plurality of days over a plurality of previous years.

Operations 10 may include a step 14 of constructing a plurality of historic hypothetical trades of the stock. Step 14 may alternately be considered as simulating a plurality of historic hypothetical trades. The plurality of historic hypothetical trades are hypothetical in the sense the trades did not actually occur. However, owing to the historic pricing information for the stock, it is knowable whether the hypothetical trades would have made or lost money had the trades actually occurred. Further, owing to the large amount of data available regarding the price of stocks, it is possible to construct a number of historic hypothetical trades in order to find when it would have been most advantageous to buy and sell a particular stock.

Constructing or simulating the plurality of historic hypothetical trades of the stock may include constructing or simulating a common-day trade. A common-day trade contains a number of individual trades, with each individual trade occurring during a particular previous year chosen from a predetermined number of previous years. The predetermined number of previous years may be referred to as “N.” Each individual trade within the common-day trade is characterized by: (a) a common start business day, (b) a common end business day, and (c) a common designation as either a long trade or a short trade.

Simulating a common-day trade containing a plurality of individual trades may alternately be referred to as simulating a set of simulated trades including a plurality of simulated trades. Each trade within a set starts on a common start day during a different past calendar year and extends for a common duration between simulated purchase and sale of the stock.

An example of a common-day trade includes five hypothetical long trades of stock IBM, one for each year from 2011 to 2015, where each trade begins on the 13^{th} business day of the respective year and ends on the 21^{st} business day of the respective year. The five hypothetical long trades are the individual trades, and the common-day trade is characterized by the stock in question, the number of previous years, the common start business day of the 13^{th}, the common end business day of the 21^{st}, and that each of the individual trades is a long trade.

The common start business day of the year may be within a start range of business days. In some examples, if an analysis of historic stock price information is being performed on the 115^{th} business day of the current year, the start range of business days for the historic hypothetical trades may include the 115^{th} business day of the year. Then, if a seasonal effect that begins on the 115^{th} day is discovered, an actual trade of the identified stock may be initiated on the 115^{th} business day of the current year. In some examples, the start range of business days may include the 115^{th} business day and a number of days after the 115^{th} business day. Then, if a seasonal effect that begins on, say, the 117^{th} business day is discovered, an actual trade of the identified stock may be initiated on the 117^{th} business day of the current year. In some examples, operations 10 may include a step of receiving a user-selected value of the start range of business days.

The common end business day of the year may occur a predetermined number of business days after the common start business day. Operations 10 may further include a step of receiving a user-selected value of the predetermined number of business days after the common start business day that the common end business day occurs. A length or duration of the trade may be the number of business days between the common end business day and the common start business day. The hypothetical trades may begin at opening on the start business day and end at closing on the end business day. In the case where the common start business day is the same as the common end business day, the predetermined number of business days may be said to be one. In the case where the common end business day is the next business day after the common start business day, the predetermined number of business days may be said to be two, etc. A seasonal effect may last any amount of time between one day and a full year. Thus, the length of the trade may be between one day and one year. In some examples, the predetermined number of business days may fall in the range of one to thirty days or in the range of one to ten days, among others.

The common-day trade may contain individual trades which are all long trades or all short trades. A seasonal effect may be a rise or a fall in stock price that occurs over the same time period every year. If the stock price rises every year at the same time, then a long trade would yield a profit. If the stock price falls every year at the same time, then a short trade would yield a profit. The common designation as either a long trade or a short trade indicates which kind of individual trades are contained within the common-day trade.

Operations 10 may include a step 16 of determining a gain or a loss for each individual trade within the common-day trade. This determination may be based on the historical pricing information for the stock. Determining a gain or a loss for each trade may include determining a number of profitable individual trades within each common-day trade, wherein each of the profitable individual trades would have yielded a profit had it been made.

Continuing the example trade of IBM stock above, it may be that four of the long individual trades would have yielded a profit or gain had they been made and one of the long individual trades would have yielded a loss had it been made. That is, in four of the five years the stock price would have gone up between opening on the 13^{th} day and closing on the 21^{st} day and a long trade would have yielded a profit.

Operations 10 may include a step 18 of determining an accuracy of the common-day trade as a ratio of the number of profitable individual trades within the common-day trade to the predetermined number of previous years N. In the prior example trade of IBM stock, the accuracy of the common-day trade would be 80%, as four out of five individual trades would have been profitable.

Steps 16 and 18 may alternately be referred to as determining a fraction of simulated trades within the set of simulated trades that would have yielded a profit if the simulated trades had been made.

Operations 10 may include a step 20 of determining if the accuracy of the common-day trade is above a specified accuracy threshold or a threshold ratio. Alternately, step may include determining if the fraction of simulated trades that would have yielded a profit exceeds a predetermined minimum fraction. In other embodiments, step 20 may include determining if the accuracy of the common-day trade is above or equal to a specified accuracy threshold or threshold ratio. In some examples, the specified accuracy threshold may be specified by a user of the processing device performing operations 10.

If is determined at step 20 that the accuracy of the common-day trade is above the specified accuracy threshold, then operations 10 may proceed to a step 22 of adding the common-day trade to a list of profitable common-day trades. That is, an entry may be created on a list of profitable common-day trades. The entry may include: (a) the common start business day of the year for the individual trades within the common-day trade, (b) the common end business day of the year for the individual trades within the common-day trade, and (c) the common designation of the individual trades within the common-day trade as wither a long trade or a short trade. The entry may include any other relevant information about the common-day trade, such as the identified stock, the accuracy of the common-day trade, the hypothetical profit or loss for each of the individual trades within the common-day trade, etc. and/or the like.

However, if it is determined at step 20 that the accuracy of the common-day trade is not above the specified accuracy threshold, then operations 10 may proceed to a step 24 of not adding the common-day trade to the list of profitable common-day trades. That is, the common-day trade may only be added to the list of profitable common-day trades if the accuracy of the common-day trade is at or above the specified accuracy threshold. Continuing the IBM example above, if the specified accuracy threshold were set at 65%, then the common-day trade would be added to the list of profitable common-day trades. If the specified accuracy threshold were set at 90%, then the common-day trade would not be added to the list.

Operations 10 may proceed from step 22 and/or step 24 to a step 26 of determining if all common-day trades have been evaluated. A common-day trade may be considered to have been evaluated if the common-day trade has been constructed at step 14, the individual trades contained within the common-day trade considered at step 16, the accuracy of the common-day trade determined at step 18, the accuracy of the common-day trade compared to the specified accuracy threshold at step 20, and the common-day trade has either been added to the list of profitable common-day trades at step 22 or not added at step 24. All of the common-day trades may have been evaluated if every possible combination of: (a) the common start business day of the year within the start range of business days, (b) the predetermined number of business days between the common start business day and the common end business day, and (c) the common designation as either a long trade or a short trade has been evaluated. The predetermined number of business days between the start and the end of the trade, i.e. the length of the trade, may be a fixed number or a number from a specified range of trade lengths.

Thus, operations 10 may include constructing a plurality of common-day trades and each of the steps between and including steps 14 and 26 may be performed for each of the plurality of common-day trades. Alternately, operations may include simulating a plurality of sets of simulated trades and each of the steps between steps 14 and 26 may be performed for each of the plurality of sets of simulated trades.

If it is determined at step 26 that not all common-day trades have been evaluated, then operations 10 may proceed to step 14 where a new common-day trade is constructed. The new common-day trade may differ from the previous common-day trade by changing the common start business day, the length of the trade, the designation of the trade as either long or short, or any combination of the three. Operations 10 may continue in the feedback loop between steps 14 and 26 until all possible common-day trades, within the specified criteria, have been evaluated.

If it is determined at step 26 that all common-day trades conforming to the specified criteria have been evaluated, operations 10 may proceed to a step 28 of displaying the list of profitable common-day trades. That is, step 28 may include displaying, on a graphical user interface, a graphical representation of the profitable common-day trades.

FIG. 2 shows an exemplary display of profitable trades, generally indicated at 40. Displaying the list of profitable common-day trades may include generating the display of profitable trades 40. The display 40 may include a graphical bar 42, also referred to as a bar, for every entry on the list of profitable common-day trades. FIG. 2 shows nine such bars, indicated at 42a-42i, corresponding to nine entries on the list of profitable common-day trades. Each graphical bar 42a-42i has (a) a first end 44a-44i disposed on the display to indicate the common start business day of the year for the individual trades within the common-day trade, alternately termed the common start date of the simulated trades of the set, (b) a second end 46a-44i disposed on the display 40 to indicate the common end business day of the year for the individual trades within the common-day trade, and (c) a non-alphanumeric visual indication 48a-48i of the common designation of the individual trades within the common-day trade as either a long trade or a short trade.

The non-alphanumeric visual indication 48 may be a colored shading of the graphical bar 42, with a first color if each of the simulated trades of a set has a common designation as a long trade and a second color if each of the simulated trades of a set has a common designation as a short trade. Alternately, the non-alphanumeric visual indication may include two distinct grey-scale shadings, two distinct hatching patterns, or any other way besides the use of numbers or letters to distinguish between long trades and short trades.

Display 40 is organized into a plurality of rows 50a-50i and a plurality of columns 52. Each row may correspond to an entry on the list of profitable common-day trades. A subset 54a-j of the plurality of columns may correspond to business days of the year. A subset 56 of the plurality of columns may correspond to data associated with each entry on the list of profitable common-day trades.

As an example from FIG. 2, bar 42a disposed within row 50a has a first end 44a disposed in column 54b to indicate that a first profitable common-day trade 58a begins on the second business day of the year. Bar 42a has a second end 46a disposed in column 54e to indicate that the first profitable common-day trade ends on the fifth business day of the year. A length of the first profitable common-day trade is four business days.

Each graphical bar 42 may have a primary segment length 60 representing the common duration of the simulate trades of the set. For example, bar 42a has a primary segment length 60a spanning four columns 54 on display 40 to indicate a duration of four business days and bar 42d has a primary segment length 60d spanning three columns to indicated a duration of three business days between the simulated purchase and sale of the stock.

Bar 42a has a non-alphanumeric visual indication 48a, in this case a shading of the area of bar 42a, to indicate that the first profitable common day trade is a long trade. Similarly, a second profitable common-day trade 58b begins on the sixth day of the business year, ends on the 9th business day of the year. As indicated by a different shading of graphical bar 42b as compared to the long trade 58a, the second profitable common-day trade 58b is a short trade.

The display of profitable trades 40 depicted in FIG. 2 is similar to a Gantt chart used to illustrate a project schedule, with time generally flowing from left to right across the chart. Gantt charts typically represent the start and end dates of the subprojects and activities within an overarching project. Gantt charts can be used to indicate which subprojects can be completed in parallel and which need to be completed serially. The display 40 in FIG. 2 borrows the time-flow aspect of the Gantt chart to illustrate the start and end dates of the historic hypothetical trades. However, unlike the Gantt chart, the rows in FIG. 2 do not depend upon one another.

A display such as display 40 may facilitate the visual identification of season effects in historic stock price data. For example, FIG. 2 shows a number of different, profitable, long common-day trades which begin on about the second business day, namely trades 58a, 58c, and 58e-g, and end on about the fifth business day. These profitable long trades generally “line up” vertically with one another because of the similar start business days 44 and end business days 46 along with the similar shading. A user may identify the vertical alignment of the similar common-day trades by looking at display 40. The vertical alignment may indicate a seasonal effect of a rise in stock price between the second and fifth business days.

Similarly, FIG. 2 shows a number of different, profitable, short common-day trades which begin on about the sixth business day and end on about the ninth business day, namely trades 58b, 58d, and 58h-i. Again, these short trades are roughly stacked vertically on top of one another on the right hand side of the display 40. This may indicate a seasonal effect of a drop in stock price between the sixth and ninth business days.

Column 56 may include any appropriate data associated with each entry on the list of profitable common-day trades. For example, column 56 may include the start business day of the common-day trade, the length of the common-day trade, the total profit which would have been earned had each of the individual trades within the common-day trade been made, the average profit of the common-day trade over the previous N years, the accuracy of the common-day trade, etc.

The rows 50 in display 40 may be sorted or arranged according to any appropriate criteria. In some examples, the rows may be ordered according to data in column 56, such as the accuracy of the common-day trades or the total profit which would have been earned. That is, the graphical bars may be displayed in an order based on the fraction of simulated trades within each graphically represented set of simulated trades that would have yielded a profit if the simulated trades had been made. In some examples, the graphical bars may be displayed in an order based on the average profit that would have been obtained if the simulated trades of the corresponding set had been made.

In some examples, the rows and columns of the display of profitable trades may be interchanged, so that time proceeds in a vertical direction instead of a horizontal direction.

In some examples, the non-alphanumeric visual indication 48 may indicate other information, along with the designation as either a long or a short trade, such as the accuracy of the common-day trades. If the non-alphanumeric indication is a shading or other visual pattern within a bar 42, a percentage of the bar that is filled by the non-alphanumeric indication may correspond to the accuracy of the common-day trade. In some examples, the graphical bar 42 may have a secondary segment length contained within the primary segment length 60 such that a ratio of the secondary segment length to the primary segment length indicates the fraction of simulated trades that would have yielded a profit. The secondary segment length may be displayed in a first color, such as to indicate the common designation as a long or a short trade, while a portion of the primary segment length that does not include the secondary segment length may be displayed in a second color, for example a neutral color such as white. Continuing the IBM example above, if the common-day trade included profitable individual trades in four out of five years, then the corresponding bar may be 80% filled by the non-alphanumeric visual indication, thereby giving a non-alphanumeric visual indication of the accuracy of the common-day trade.

### Example 2

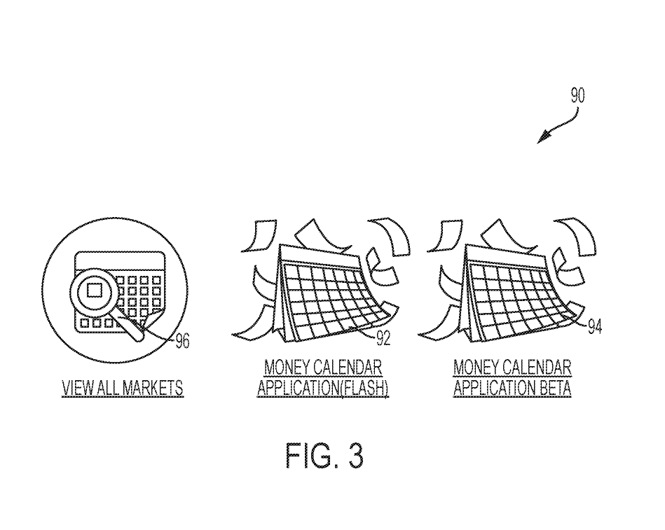

This example describes illustrative embodiments of a money calendar tool; see FIGS. 3-13. The embodiments described herein may perform the method of displaying seasonal effects and/or patterns in historic stock price data described above in reference to FIGS. 1 and 2. The embodiments described herein may perform these methods using a processing device and may display results on a graphical user interface.

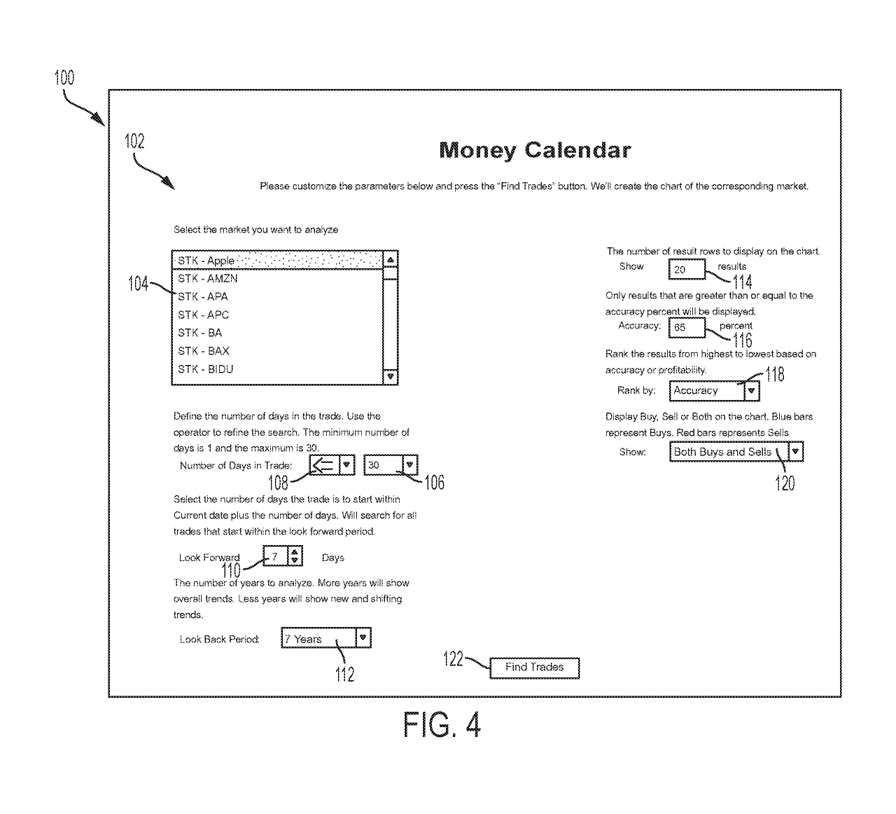

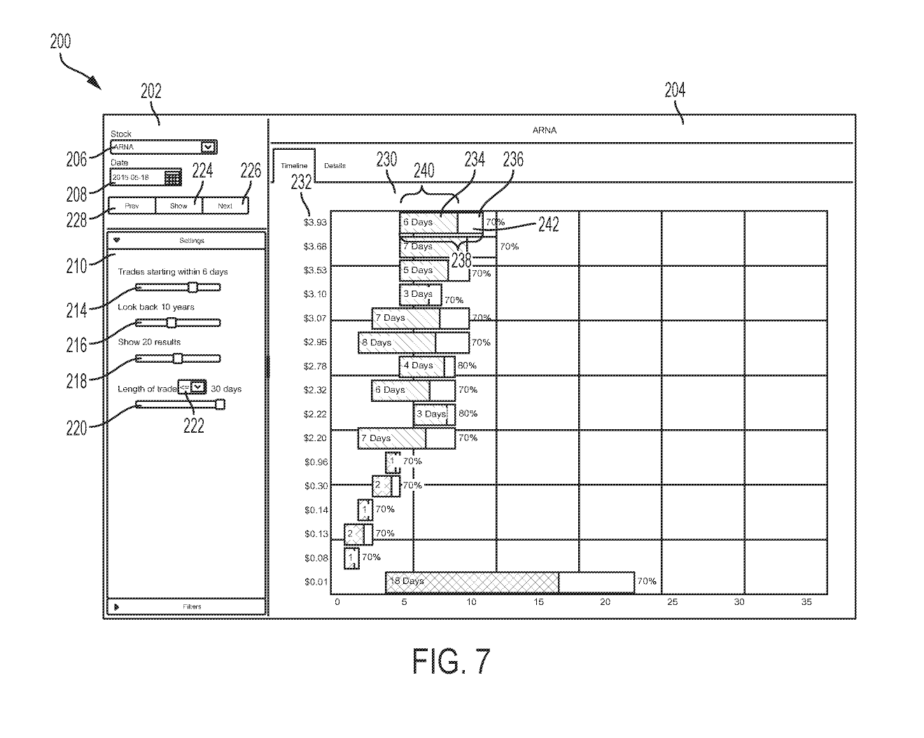

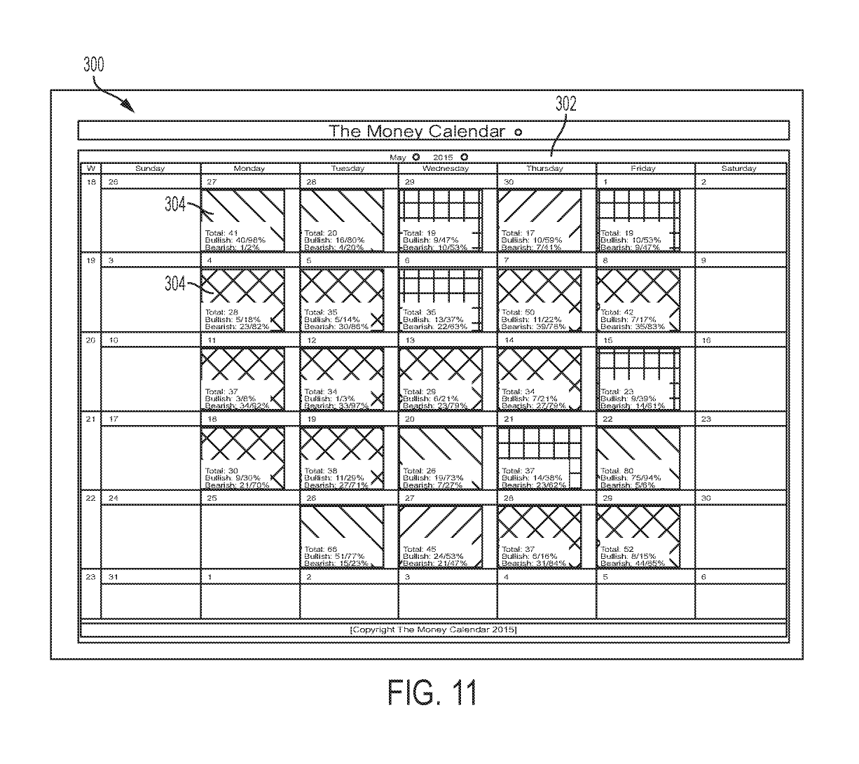

FIG. 3 is a screenshot depicting an embodiment of a main menu, generally indicated at 90. Main menu 90 may be displayed on a graphical user interface of a computing device, such as a desktop computer, a laptop computer, a tablet, a smartphone, or any other appropriate device. Main menu 90 may include a money calendar button 92, a mobile money calendar button 94, and an all-market money calendar button 96. By selecting the money calendar button 92, a user may gain access to a money calendar tool depicted and described in reference to FIGS. 4-6. By selecting the mobile money calendar button 94, a user may gain access to a mobile money calendar tool depicted and described in reference to FIGS. 7-10. By selecting the all-market money calendar button 96, a user may gain access to an all-market money calendar tool depicted and described in reference to FIGS. 11-13.

FIG. 2 is a screenshot depicting an embodiment of a money calendar tool, generally indicated at 100. Money calendar tool 100 may be a software application running on a computing device. A user may access money calendar tool 100 by selecting the money calendar button 92 in the main menu. Money calendar tool 100 may include a parameter selection tool, generally indicated at 102. The parameter section tool 102 may be displayed on the graphical user interface of a computing device. Money calendar tool 100 may search the historical record of stock prices according to the parameters selected in parameter selection tool 102.

Parameter selection tool 102 may have several fields where a user can specify a set of parameters related to the historical price of a stock. Parameter selection tool may include a market menu 104 from which a user may select or identify a particular stock for historical price analysis. Stocks may be listed in market menu 104 by their stock ticker name. Alternately, a user may enter a particular stock into an input field.

Parameter selection tool 102 may include a trade length or duration selector 106. The trade length selector may be a menu from which a user may select an integer number of days from a range of one to thirty days. Alternately, a user may enter a number of days into an input field. To understand the “length” of a trade, imagine an example where a trade is initiated by buying a number of shares of a particular stock as the market opens on a particular day. The day on which the shares are purchased may be referred to as a first day. If the length of the trade is one day, those same shares of stock are then sold as the market closes on the first day. If the length of the trade is two days, then those same shares of stock would be sold as the market closes the day after the first day, that is, on the second day, etc. This is an example of a long trade, where stock is bought with the expectation of selling the stock at a later date.

In the above example, if the price of the stock goes up during the time between when the stock is purchased and when it is sold, then whoever bought and sold the stock will have made a profit.

In another example, a trade may occur where an amount of stock is sold at opening on the first day, and the same amount of stock purchased on the Xth day, where the number X can range from one up to thirty days. In this example, if the price of stock drops between when it is sold and then purchased, then whoever sold and bought the stock will have made a profit. This is an example of a short trade, where stock is sold with the expectation of buying the stock back at a later date.

The days in the length of the trade may be business days instead of calendar days. That is, only days where trading actually occurs are counted, omitting weekends and holidays when no trading takes place. This may allow the money calendar tool to more accurately compare prices changes from one year to the next.

The trades considered by money calendar tool 100 are not actual historical trades that were made. Rather, they represent what would have happened had a person or institution bought or sold a stock at opening on a particular day, and then sold or bought that stock at closing on that same day or a later day. In this sense, the trades considered by tool 100 are simulated or hypothetical.

Parameter selection tool 102 may include a trade length modifier 108. Trade length modifier 108 may be a menu from which a user may select from the choices: less than or equal to, greater than or equal to, or equal to. For example, were a user to select less than or equal to from the trade length modifier 108, then money calendar tool 100 would consider trades of a length in a range between 1 day and the number of days selected in the trade length selector 106, inclusive. In another example, were a user to select greater than or equal to from the trade length modifier, then money calendar tool 100 would consider trades of a length in a range between the number of days selected in the trade length selector and 30 days, inclusive. In still another example, were a user to select equal to from the trade length modifier, then money calendar tool 100 would consider trades of a length exactly equal to the number of days selected in the trade length selector.

Parameter section tool 102 may include a look forward selector 110. The look forward selector may allow a user to specify a range of days during which a trade is to begin. For example, if the look forward selector is set to one day, then all trades may have the same start day. The start day may correspond to the current business day or the following business day. In other examples, if the look forward selector 110 is set to two days, then money calendar tool 100 may consider trades starting on the first day and the second day. The look forward selector may be set to a number of days within a range of one to 10 days, though larger ranges are also possible.

Parameter selection tool 102 may include a look back period selector 112. The look back period selector 112 may allow a user to specify a number of years prior to the current year to analyze. For example, if the look back selector 112 is set to 7 years, then the money calendar tool will review stock price data for the previous 7 years, within the constraints of the other choices made in the parameter selection tool 102. Traditional seasonal analyses have a set length for the historical look back period of 20 years. By allowing the user to specify a shorter amount of time to consider, the money calendar tool may allow the user to identify new seasonal trends that may be emerging. The look back period selector may be set to a number of years in a range of three to 18 years, though other ranges are also possible.

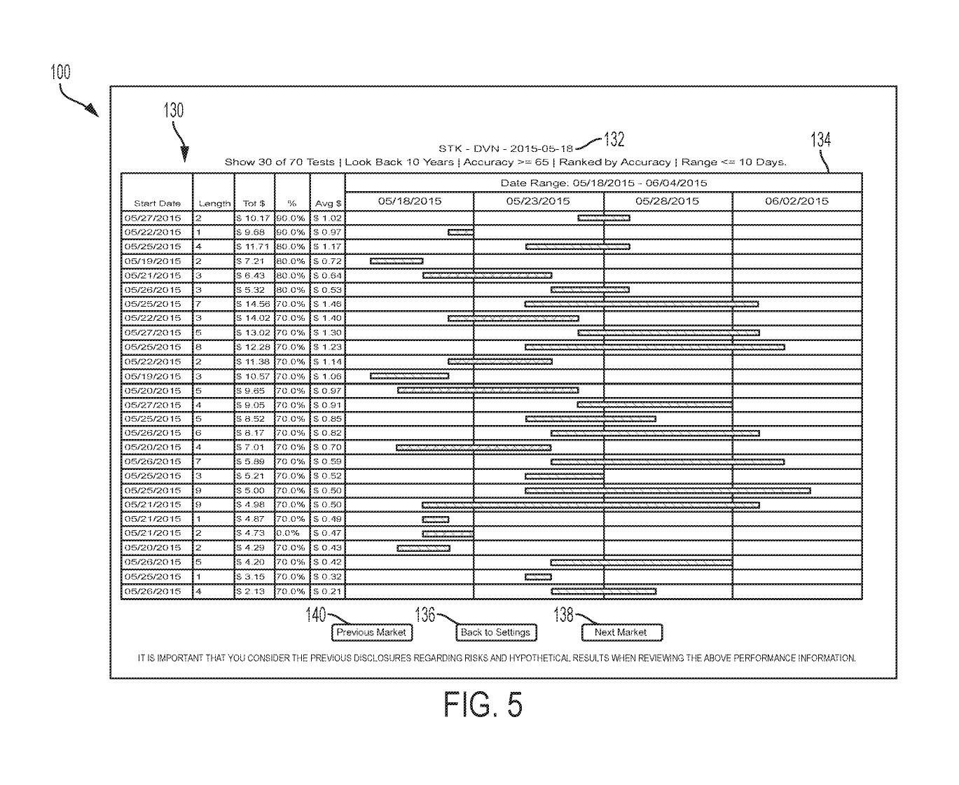

Parameter selection tool 102 may include a row display selector 114. The row display selector 114 may allow a user to specify the maximum number of trades displayed in the result display tool depicted in FIG. 5. A user may specify any number of trades to be displayed by entering an integer greater than or equal to one in the row display selector.

Parameter selection tool 102 may include an accuracy selector 116. The accuracy selector may allow a user to set an accuracy value as a filter for the historical price data search conducted by the money calendar tool. The accuracy may be a percentage of the number of years considered where trading the particular stock would have yielded a profit, within the constraints of the other choices made in the parameter selection tool 102. For example, if the accuracy selector 116 is set to 50%, then only trades that would have resulted in profit for at least half of the years considered will be displayed in the result display tool depicted in FIG. 3.

Parameter selection tool 102 may include a ranking selector 118. Ranking selector 118 may allow the user to set the criteria by which the results are ordered in the result display tool depicted in FIG. 3. Ranking selector 118 may allow the user to choose between a menu of choices, including accuracy, total profit, average profit, length of trade, and start date, among others.

Parameter selection tool 102 may include a buy/sell selector 120. Buy/sell selector may allow the user to specify which kinds of trade will be displayed in the result display tool depicted in FIG. 3. Buy/sell selector 120 may allow a user to choose between a menu of choices, including buys only where stock is bought on the first day, sells only where stock is sold on the first day, and both buys and sells. Buy trades may be referred to as long trades and sell trades may be referred to as short trades.

Money calendar tool 100 may include a find button 122. By selecting the find button a user may direct the money calendar tool to search historical stock price data according to the parameters and filters specified by the user in the parameter selection tool. That is, the money calendar tool may construct a plurality of historic hypothetical trades or simulate a plurality of sets of simulated trades according to the parameters and filters specified in the parameter selection tool. A non-limiting example search will now be discussed based on the selected parameters indicated in FIG. 4.

In this example, a user chooses to look at historical stock price data for Apple. The number of business days in the trade will be less than or equal to 30 days, and the start date will be within 7 business days of the current date, business day 95 for the purposes of the example. The look back period has been set to 7 years. Thus, the money calendar tool 100 will look at the price of Apple stock over the last 7 years, from the business day 95 up to business day 132 in each of those years. The money calendar tool will then calculate the profit that could have been made for trades up to a length of 30 days within that window. For a given start date and length of trade, an accuracy is computed by calculating what fraction of those 7 years yielded a profit. Money calendar tool 100 also calculates the total profit that would have been made over those seven years if the trades had been made in each of those years.

Continuing the example, the user has selected other parameters that will determine how the results of the search are displayed in the result display tool. In this example 20 trade results will be shown, and only those trades which yielded a profit in at least 65% of the last 7 years will be shown. The results will be ranked by accuracy in the display and both buy (long) and sell (short) trades will be shown.

FIG. 5 is a screenshot depicting an embodiment of a result display tool, generally indicated at 130, of money calendar tool 100. The result display tool 130 may be displayed on a graphical user interface of a computing device. A user may arrive at the result display tool by selecting the find button 122 depicted in FIG. 4. The result display tool 130 may include a parameter display 132 and a results table 134. Result display tool 130 may be similar to the display of profitable results 40 described in Example 1.

Parameter display 132 may include some or all of the choices made in parameter selection tool 102. In the exemplary embodiment shown in FIG. 3, the parameter display includes the name of the stock chosen, DVN, and the day that the search was completed, May 18, 2015. The parameter display further shows that the user set the row display selector to 30 results, the look back period selector to 10 years, the accuracy selector to 65%, and the trade length selector to less than or equal to 10 days. The results are ranked by accuracy, with more accurate results towards the top of the results table as a result of choosing accuracy from the ranking selector.

Results table 134 may display the results of the search conducted by the money calendar tool 100. Results table 134 may be a combination of a table and a Gantt-style chart. The results table may contain columns corresponding to the start date of a trade, the length of a trade in business days, the total profit earned in dollars per share, the accuracy of the trade, the average profit earned in dollars per share per year.

The Gantt-style chart included in results table 134 may be a visual representation of the length of a trade, the start and end dates of the trade, and whether the trade was a long or a short trade. Each row in the Gantt-style chart may correspond to the adjacent horizontal row in the table. The horizontal axis of the Gantt-style chart may be time, measured in days. The left end of a bar in the Gantt-style chart may correspond to the start date of the trade and the right end of a bar in the Gantt-style chart may correspond to the end date of the trade. The bars in the Gantt-style chart may be color coded to indicate whether the trade was a long or a short trade. For example, the bars may be green if the trade was long and red if the trade was short.

A non-limiting example will now be described, explaining the results contained within results table 134. In particular, the third row of results table 134 shown in FIG. 5 will be described. Row three lists a start date of May 25, 2015. This is the 95^{th} business day of the year. The money calendar tool has calculated the profit that would have been made, had stock in DVN been purchased on the 95^{th} business day in each of the last 10 years and then sold four days later on the 98^{th} business day, that is, if the trades were long trades. The total profit is listed at $11.71 per share. The accuracy is listed as 80%, indicating that in 8 of those 10 years a profit was achieved. The average profit listed is the total profit divided by the 10 years. The third row in the Gantt-style chart contains a green bar. This bar is a visual representation of the start date of May 25, 2015, the length of the trade of four days, and the fact that long trades during those four days resulted in profit in 80% of the last 10 years.

The results in results table 134 have been ranked by accuracy, with the more accurate results listed at the top. The results could have been ranked instead by profit. The choice to rank the results by accuracy or profit may allow a user to prioritize certainty or profit, respectively. In another embodiment the results table could be sortable by any of the columns included in the results table.

The visual display of results table 134 may provide an advantage to a user in identifying seasonal effects. In the example shown in FIG. 5, there are several short trades which begin on or around the 21^{st} of May that last around 3 days. Since these short trades earned a profit, the price of stock must have decreased on average. These short trades have roughly the same starting and ending dates and are all colored red. In the Gantt-style chart these trades are roughly lined up vertically.

Further, there are several other long trades which begin on or around the 26^{th} of May that last around 6 days. Since these long trades earned a profit, the price of stock must have increased on average. These trades are all colored green and are lined up vertically with each other. Thus, there may be a seasonal effect where the price of DVN stock decreases for a few days, beginning around the 21^{st} of May, and then rises for several days, beginning around the 26^{th} of May. Knowledge of this seasonal effect may help an investor maximize profit while minimizing risk.

Result display tool 130 may include a back button 136. By selecting the back button 136 a user may be returned to the parameter selection tool 102 to begin a new search.

Result display tool 130 may include a next button 138 and a previous button 140. By selecting the next button 138, the result display tool 130 may display the results of a search where all of the parameters entered into parameter selection tool 102 have remained the same except for the choice of stock which will have advanced by one. That is, selecting the next button 138 may have the same effect as first selecting the back button 136, then changing only the stock chosen in the market menu 104 to the next stock on the list, and finally selecting the find button 122.

Selecting the previous button 140 may have a similar effect as selecting the next button, except with moving in the opposite direction through the listed stocks. That is, selecting the previous button may keep all the parameters of the search the same except the chosen stock, which will have advanced by one in the opposite direction as when the next button is selected.

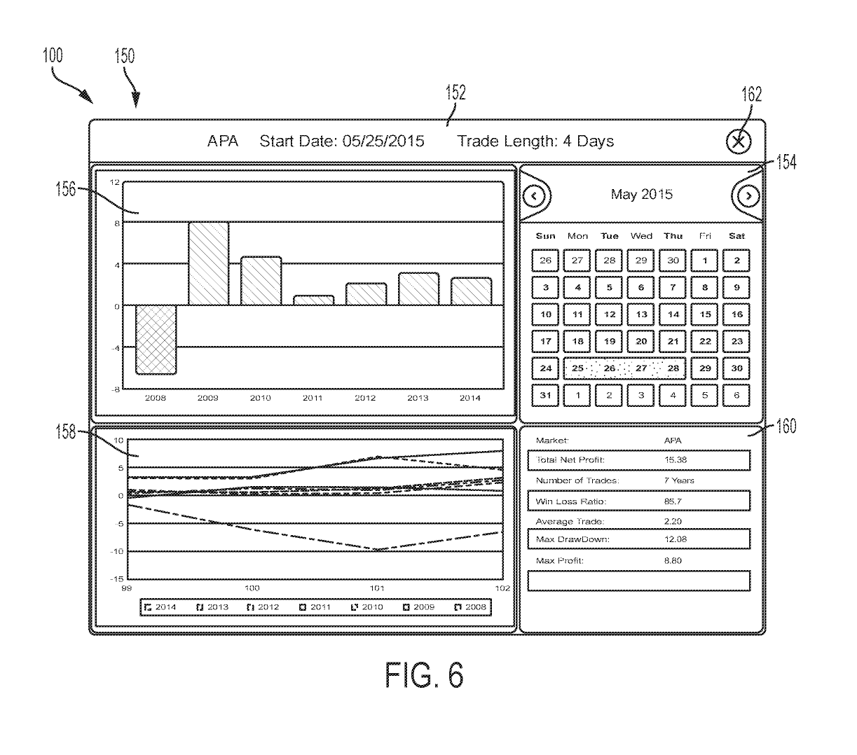

As described above, each bar in the Gantt-style chart of the results table 134 represents an average performance over a number of past years. By selecting any one of the bars in the Gantt-style chart a trade detail display may be presented to the user, see for example FIG. 6.

FIG. 6 is a screenshot depicting an embodiment of a trade detail display, generally indicated at 150, of money calendar tool 100. Trade detail display 150 may be displayed on a graphical user interface of a computing device. A user may arrive at trade detail display 150 by selecting a bar from the Gantt-style chart of the results display tool 130. In the example shown in FIG. 6, a long trade was selected. Trade detail display 150 may include a trade summary 152, a calendar pane 154, a yearly trade results graph 156, a daily trade results graph 158, and a results summary pane 160.

Trade summary 152 may include information regarding the trade, for example, the stock considered, the start date from the current year, and the length of the trade in days.

Calendar pane 154 may include a display of a calendar month. The days corresponding to the trade may be highlighted or shown in a different color than the rest of the days.

Trade detail display 150 depicts a portion of the results of an exemplary search of historical stock price data. In the exemplary search indicated in FIG. 5, seven years of historical data were searched. Yearly trade results graph 156 shows the profit made per share over the four day trade for each of the seven years. For example, in 2009 over the corresponding four business days, a trade would have made a profit of approximately eight dollars per share. In 2008 a trade would have lost approximately 6.5 dollars per share. Since a profit is shown in six of the seven years, such a trade would be said to have an accuracy of 85.7%.

Daily trade results graph 158 may depict the performance of the stock in each year over the course of the length of the trade. The stock may be purchase at opening on the first day. Daily results graph 158 may display a curve indicating the price at closing for each of the days of the trade, relative to the opening price on the first day, with a separate curve for each historical year. For example, in 2008 at closing on the 99^{th} business day, the stock price for APA was 1.6 dollars lower than the price at opening on the 99^{th} day. On the 101^{st} day, APA was 9.65 dollars lower at closing than at opening on the 99^{th} day. Finally, by the end of the four day trade, APA was 6.5 dollars lower than at the beginning of the trade. This corresponds to the loss shown for 2008 in the yearly trade results graph 156.

Results summary pane 160 may include a summary of the details of the trade for which trade detail display 150 is showing details. Such a summary may include one or more of the following: the stock chosen, the total profit made over the years studied, the number of years studied, the percentage of years in which a profit is indicated, the average yearly profit of the trade, the maximum amount of money that could have been lost, and the maximum amount of money that could have been made, among others.

Trade detail display 150 may include a close button 162. By selecting close button 162 a user may exit trade detail display 150 and return to the result display tool 130 depicted in FIG. 5.

FIG. 7 is a screenshot depicting an embodiment of a mobile money calendar tool, generally indicated at 200. Mobile money calendar tool 200 may be a software application running on a computing device and may be displayed on a graphical user interface of a computing device. Mobile money calendar tool 200 may accomplish many of the same tasks as money calendar tool 100. The display and user interface of mobile money calendar tool 200 may be configured to be used on a tablet, phone, or other mobile computing device.

Mobile money calendar tool 200 may combine the functionality of the parameter selection tool 102 and the result display tool of the money calendar tool 100 into a single, integrated, user interface and display.

Mobile money calendar tool 200 may include a parameter pane 202 and a display pane 204. Parameter pane 202 may have the same functionality or substantially the same functionality as parameter selection tool 102 of the money calendar tool 100. Display pane 204 may have the same functionality or substantially the same functionality as result display tool 130 of the money calendar tool 100.

Parameter pane 202 may include a market menu 206, a date menu 208, a settings pane 210, and a filters pane 212 best seen in FIG. 6. Market menu 206 may have much the same functionality as market menu 104 in money calendar tool 100. Date menu 208 may allow a user to specify the first possible starting date for a trade. The date menu may allow a user to choose a first possible starting date from a range of dates including the current business day.

Settings pane 210 may include a look forward selector 214, a look back period selector 216, a row display selector 218, a trade length selector 220, and a trade length modifier 222. Look forward selector 214 may have the same functionality as look forward selector 110 of money calendar tool 100. Look back period selector 216 may have the same functionality as look back period selector 112 of money calendar tool 100. Row display selector 218 may have the same functionality as row display selector 114 of money calendar tool 100. Trade length selector 220 may have the same functionality as trade length selector 106 of money calendar tool 100. Trade length modifier 222 may have the same functionality as trade length modifier 108 of money calendar tool 100.

Parameter pane 202 may include a show button 224, a next button 226, and a previous button 228. Show button 224 may have the same functionality as find button 122 of money calendar tool 100. By selecting the show button 224 a user may direct the mobile money calendar tool 200 to search historical stock price data according to the parameters and filters specified by the user in the parameter pane 202. The results of this search may be automatically displayed in the display pane 204 upon selecting the show button 224.

Next button 226 may have the same functionality as next button 138 of money calendar tool 100. Previous button 228 may have the same functionality as previous button 140 of money calendar tool 100.

Display pane 204 may include a timeline display 230. Timeline display 230 may be similar to results table 134 and/or the display of profitable trades 40. Timeline display 230 may include a number of rows, where each row corresponds to a trade having a start day and an end day. A row may include the total profit 232 that would have been earned by trades having the same start and end days over the historical years considered by the mobile money calendar tool. A row may include a Gantt-style chart similar to the Gantt-style chart included in results table 134. The Gantt-style chart may include a bar 234. Bar 234 may indicate the length of the trade and may be color coded. Bar 234 may be green if the trade is a buy or a long trade and red if the trade is a sell or a short trade.

A row in the timeline display may include an accuracy indicator 236. Accuracy indicator 236 may be an extension of bar 234, where the percentage of bar 234 filled with color is an indication of the percentage of historical years for which the trade would yield a profit. Accuracy indicator 236 may include a number indicating the percentage of historical years for which the trade would yield a profit.

Bar 234 may have a primary segment length 238 representing the duration of the simulate trades. Bar 234 may further have a secondary segment length 240 contained within the primary segment length such that a ratio of the secondary segment length to the primary segment length indicates the fraction of simulated trades that would have yielded a profit. The secondary segment length may be displayed in a first color, e.g. green to indicate a long trade, and a portion 242 of the primary segment length 238 that does not include the secondary segment length is displayed in a second color, e.g. white.

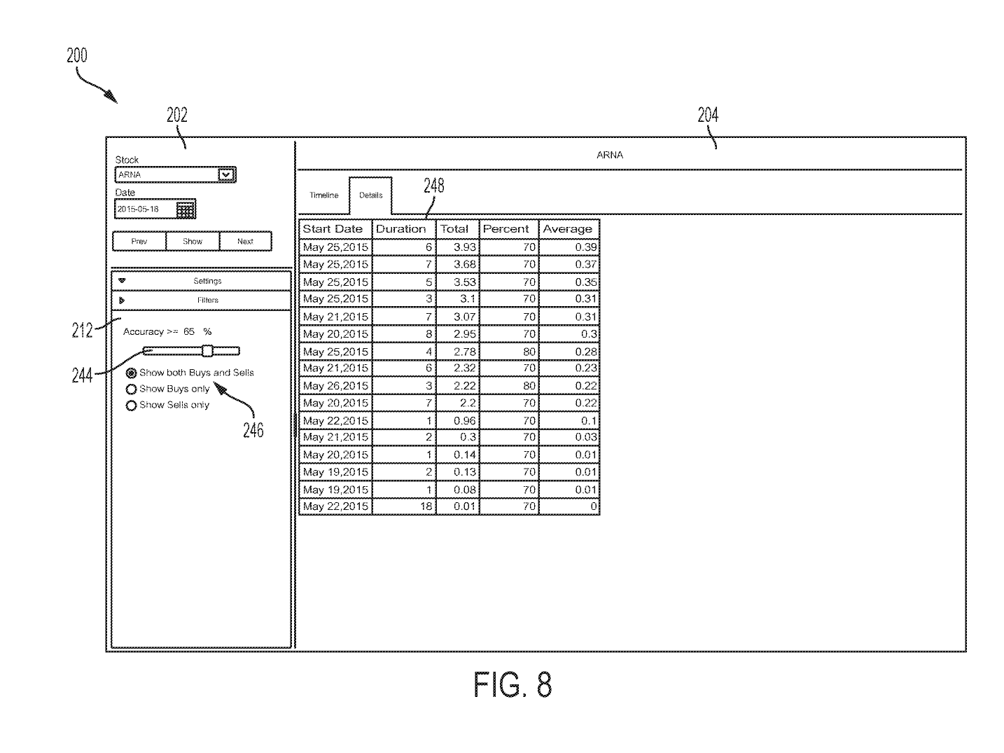

FIG. 8 is a screenshot depicting another view of mobile money calendar tool 200. In FIG. 6, filter pane 212 has replaced settings pane 210 in the parameter pane 202. In another embodiment, both the filter pane and the settings pane may be visible in the parameter pane at the same time. Alternately, the filter pane and the settings pane may be incorporated into a single pane.

Filter pane 212 may include an accuracy selector 244 and a buy/sell selector 246. Accuracy selector 244 may have the same functionality as accuracy selector 116 of money calendar tool 100. Buy/sell selector 246 may have the same functionality as buy/sell selector 120 of money calendar tool 100.

Display pane 204 may include a details display 248. Details display 248 may be a table of information summarizing the results of the search conducted by mobile money calendar tool 200. The information contained in the table of details display 248 may be the same as the information contained in results display table 134 of money calendar tool 100.

FIG. 7 depicts the settings pane 210 paired with the timeline display 230 and FIG. 8 depicts the filter pane 212 paired with the details display 242. However, either of the settings pane and the filter pane may be paired with either of the timeline display or the details display.

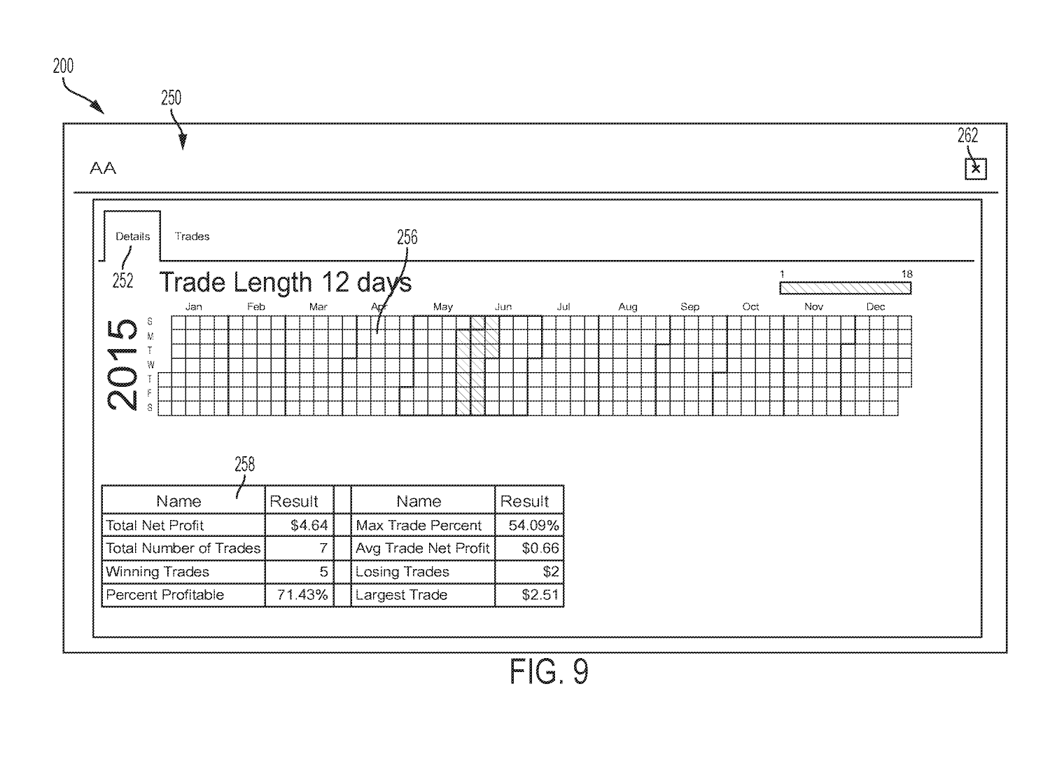

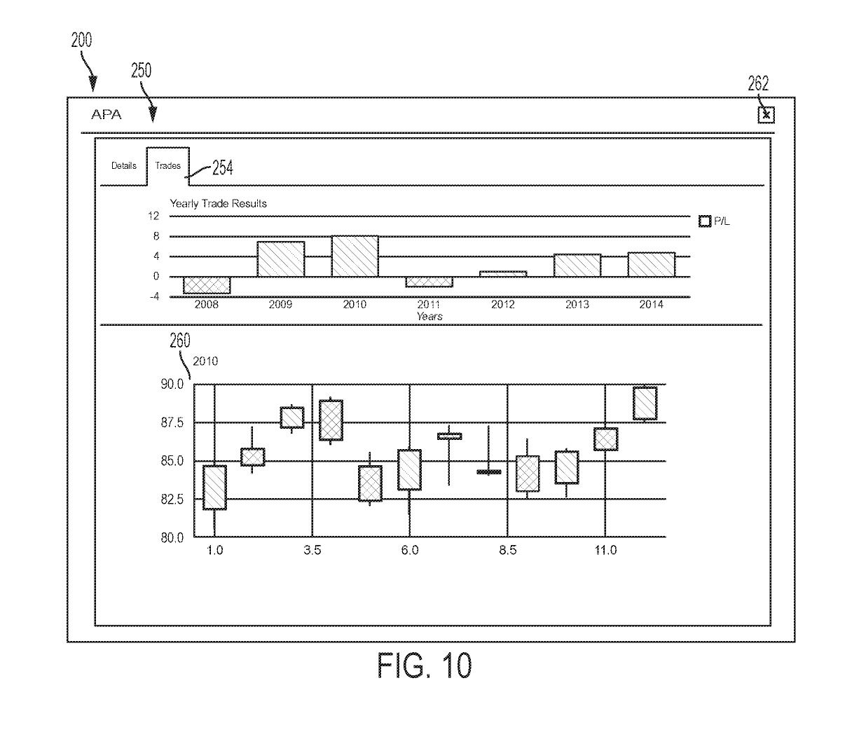

By selecting any one of the bars in the Gantt-style chart a mobile details tool may be presented to the user, see for example FIGS. 9 and 10.

FIG. 9 is a screenshot depicting an embodiment of a mobile details tool, generally indicated at 250, of mobile money calendar tool 200. Mobile details display tool 250 may be displayed on a graphical user interface of a computing device. A user may arrive at mobile details tool 250 by selecting a bar from the timeline display 230 of the mobile money calendar tool. Mobile details tool 250 may have two display modes: a trade details display 252 seen in FIG. 9 and a mobile yearly trade results graph 254 seen in FIG. 10.

Trade details display 252 may include a mobile calendar 256 and a mobile summary 258. Mobile calendar 256 may have the same functionality as calendar pane 154 of money calendar tool 100. Mobile summary 258 may include the same or much the same information as results summary pane 160 of money calendar tool 100.

FIG. 10 is a screenshot depicting an embodiment of mobile details tool 250 showing mobile yearly trade results graph 254. Mobile yearly trade results graph 254 may have the same functionality as yearly trade results graph 156 of money calendar tool 100.

By selecting a particular year from the mobile yearly trade results graph 254, the mobile details tool 250 may present the user with a candlestick chart 260. Candlestick chart 260 may present the daily performance of the chosen stock during the length of the trade for the year selected by the user in the mobile yearly trade results graph 254.

The vertical axis in the candlestick chart may represent the stock price of the chosen stock. For every day in the trade, the candlestick chart may have a solid vertical bar with vertical lines extending above and below the solid vertical bar. The vertical extent of the solid bar may represent the difference between the closing and opening price of the stock for that day. If the price dropped during the day, the solid bar may be colored red. If the price rose during the day, the solid bar may be colored green. The maximum vertical extent of the vertical line above the solid bar may represent the maximum trading price of the stock during the day. The minimum vertical extend of the vertical line below the solid bar may represent the minimum trading price of the stock during the day.

Mobile details tool 250 may include a close button 262, depicted in FIGS. 9 and 10. By selecting close button 262 a user may be returned to the mobile money calendar tool 200 depicted and described in reference to FIGS. 7 and 8.

FIG. 11 is a screenshot depicting an embodiment of an all-market money calendar tool, generally indicated at 300. All-market money calendar tool 300 may be a software application running on a computing device. A user may access all-market money calendar tool 300 by selecting the money calendar button 96 in the main menu. Money calendar tool 300 may include a monthly calendar 302. Monthly calendar 302 may be displayed on the graphical user interface of a computing device.

Monthly calendar 302 may be configured to visually depict whether the stock market as a whole is likely to move up or down. The analysis behind this determination may be similar to the analysis used by money calendar tool 100 and mobile money calendar tool 200 and described in reference to FIGS. 1 and 2. That is, the historical record of stock prices for a number of companies may be analyzed toward an end of identifying seasonal effects in individual stock prices or the market as a whole.

For a given business day, the all-market money calendar tool 300 may consider historical trades of a length less than or equal to 30 days beginning on that day for a set list of stocks. The all-market money calendar tool 300 may have a set look back period of 10 years. All-market money calendar tool 300 may then discard all trades with an accuracy of less than 90%, where accuracy is described above in reference to FIGS. 4-6.

All-market money calendar tool may search the historical data and calculate the profits and losses for hypothetical long and short trades. For example, the all-market money calendar tool found forty long trades that began on the business day corresponding to April 27^{th}, lasting any number of business days less than 31, where the trades would have yielded a profit in at least nine of the last ten years. When long trades result in profit, the stock price is generally rising. Further, the all-market money calendar tool found one short trade that began on the business day corresponding to April 27^{th}, lasting any number of business days less than 31, where the trades would have yielded a profit in at least nine of the last ten years. When short trades result in profit, the stock price is generally falling.

In the case where more stock prices are increasing, and hence, when long trades would be expected to yield a profit, the market is said to be “bullish.” In the case where more stock prices are falling, and hence, when short trades would be expected to yield a profit, the market is said to be “bearish.” Monthly calendar 302 may be configured to visually display what fraction of the qualifying trades were long trades. For example, on April 27^{th}, 40 of the 41 qualifying trades were long trades, a percentage of approximately 98%. On May 12^{th}, 1 of the qualifying 34 trades was a long trade, a percentage of 3%.

Monthly calendar 302 may color-code each day according to the percentage of qualifying trades that are long trades. If the percentage of long trades is relatively high, the day may be colored green. If the percentage of long trades is relatively low, the day may be colored red. If the percentage of long trades is roughly 50%, the day may be colored roughly half-way between red and green, that is, yellow. Thus, monthly calendar 302 may give an immediate visual impression of the direction of the market by displaying each day with a color indicating whether long trades generally make money and the market is going up, or if short trades generally make money and the market is going down.

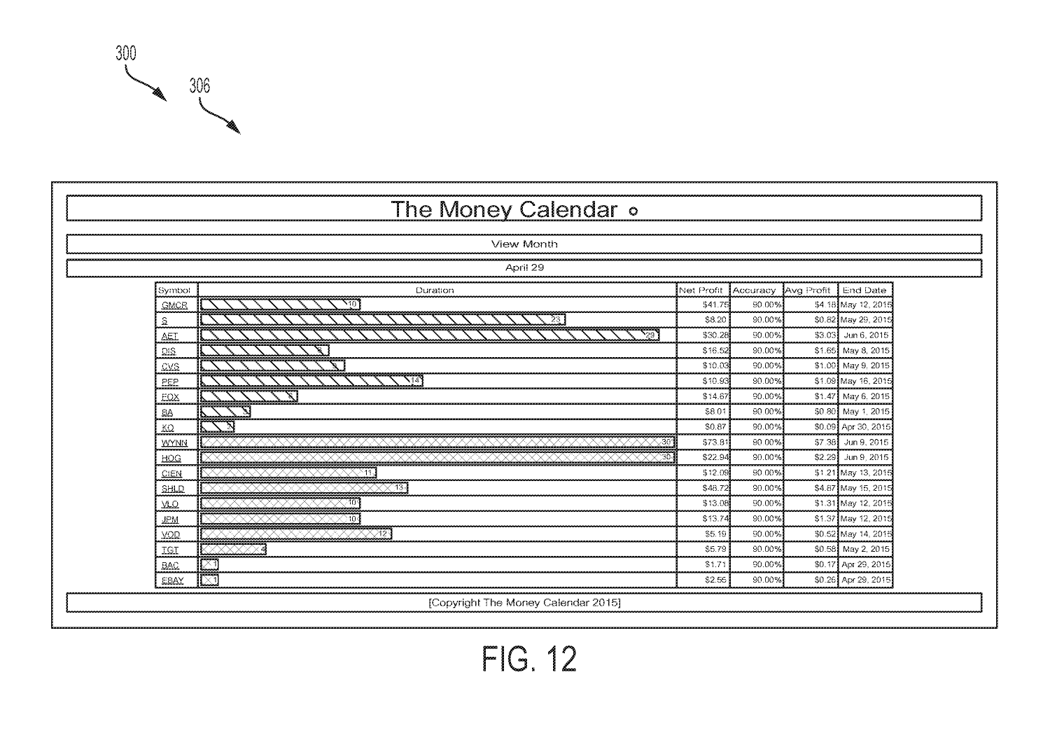

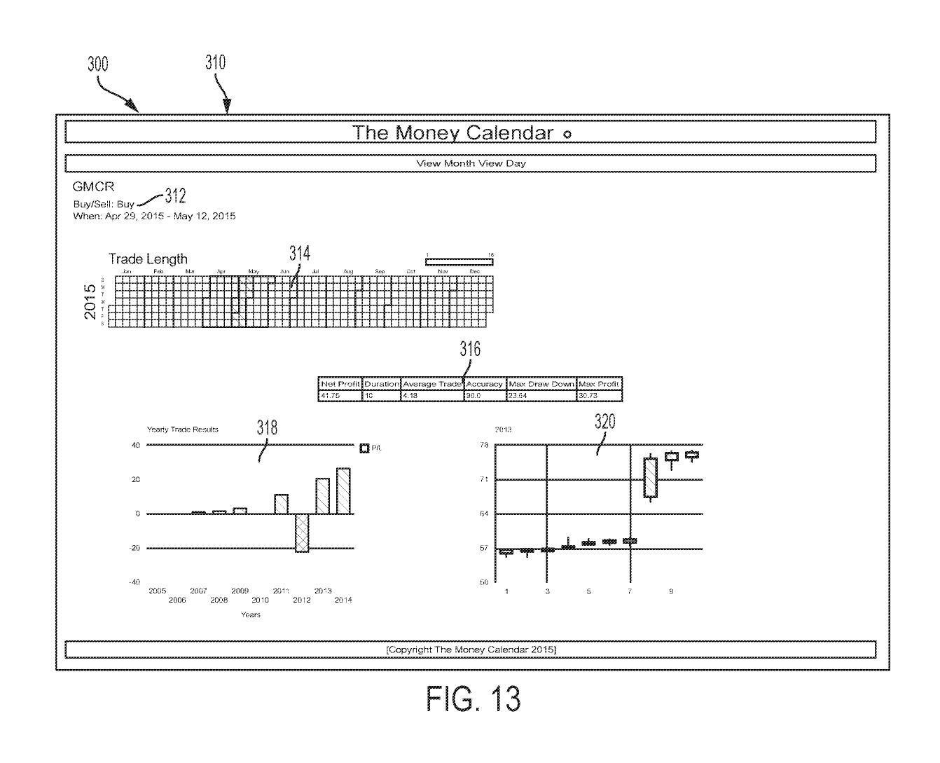

Monthly calendar 302 may include a daily brief summary 304 for each day. The daily brief summary may indicate how many trades began on that day and had an accuracy of at least 90% over the last 10 years. The daily brief summary may include how many of those trades were long trades or short trades, and may indicate the relative abundancies of each kind of trade by a percentage out of 100. A user may select a day from the monthly calendar to view a more details about the qualifying trades, see FIGS. 12 and 13.

FIG. 12 is a screenshot depicting an embodiment of a daily summary table, generally indicated at 306, of all-market money calendar tool 300. Daily summary table 306 may be displayed on a graphical user interface of a computing device. A user may arrive at the daily summary table by selecting a day from the monthly calendar 302. In the non-limiting example shown in FIG. 12, April 29^{th} was selected from monthly calendar 302.

As described in reference to FIG. 11, the all-market money calendar tool 300 may search the historical stock price data for long trades and short trades, beginning on a given day, that result in profit in at least nine out of the last ten years. In the example in FIG. 12, the all-market money calendar tool found nine historical long trades and ten historical short trades. Daily summary table 306 may display some details about those trades. For example, daily summary table may include columns indicating the name of the stock, the length or duration of the trade, the net profit made over the ten years, the accuracy of the trade, average profit over the ten years, and the end date of the trade, among others. The length of the trade may be represented by a horizontal bar. Long trades may have the bar colored green and red trades may have the bar colored red. The net profit, accuracy, and average profit may be the same as those quantities as described in reference to FIG. 5. A user may select a trade from the daily summary table 306 to view more details about a particular trade, see FIG. 13.

FIG. 13 is a screenshot depicting an embodiment of a trade detail tool, generally indicated at 310, of all-market money calendar tool 300. Trade detail tool 310 may be displayed on a graphical user interface of a computing device.

Trade details tool 310 may include a trade details summary 312. Trade details summary 312 may include the name of the stock, whether the trade was a buy or a sell, the beginning date, and the end date, among others.

Trade details tool 310 may include a calendar 314. Calendar 314 may have substantially the same functionality as mobile money calendar 256 of the mobile money calendar 200 and/or as calendar pane 154 of money calendar 100.

Trade details tool 310 may include a trade summary 316. Trade summary 316 may have substantially the same functionality as results summary pane 160 of the money calendar 100 and/or as mobile summary 258 of mobile money calendar 200.

Trade details tool 310 may include a yearly trade results graph 318. Yearly trade results graph 318 may have substantially the same functionality as yearly trade results graph 156 of the money calendar 100 and/or as mobile yearly trade results graph 254 of mobile money calendar 200.

Trade details tool 310 may include a candlestick chart 320. Candlestick chart 320 may have substantially the same functionality as candlestick chart 260 of the mobile money calendar 200.

### Example 3

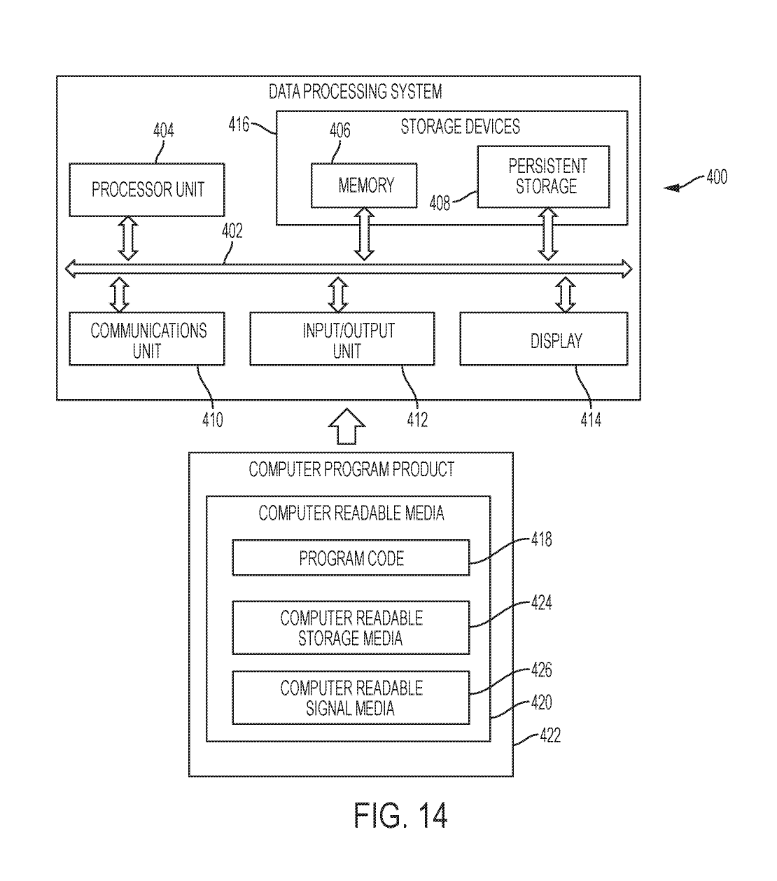

As shown in FIG. 14, this example describes a data processing system 400 in accordance with aspects of the present disclosure. In this example, data processing system 400 is an illustrative data processing system suitable for implementing aspects of a money calendar system. More specifically, in some examples, devices that are embodiments of data processing systems (e.g., smartphones, tablets, personal computers) may perform aspects of methods for analyzing historic stock price data and/or displaying seasonal effects and/or patterns in historic stock price data.

In this illustrative example, data processing system 400 includes communications framework 402. Communications framework 402 provides communications between processor unit 404, memory 406, persistent storage 408, communications unit 410, input/output (I/O) unit 412, and display 414. Memory 406, persistent storage 408, communications unit 410, input/output (I/O) unit 412, and display 414 are examples of resources accessible by processor unit 404 via communications framework 402.

Processor unit 404 serves to run instructions that may be loaded into memory 406. Processor unit 404 may be a number of processors, a multi-processor core, or some other type of processor, depending on the particular implementation. Further, processor unit 404 may be implemented using a number of heterogeneous processor systems in which a main processor is present with secondary processors on a single chip. As another illustrative example, processor unit 404 may be a symmetric multi-processor system containing multiple processors of the same type.

Memory 406 and persistent storage 408 are examples of storage devices 416. A storage device is any piece of hardware that is capable of storing information, such as, for example, without limitation, data, program code in functional form, and other suitable information either on a temporary basis or a permanent basis.

Storage devices 416 also may be referred to as computer-readable storage devices in these examples. Memory 406, in these examples, may be, for example, a random access memory or any other suitable volatile or non-volatile storage device. Persistent storage 408 may take various forms, depending on the particular implementation.

For example, persistent storage 408 may contain one or more components or devices. For example, persistent storage 408 may be a hard drive, a flash memory, a rewritable optical disk, a rewritable magnetic tape, or some combination of the above. The media used by persistent storage 408 also may be removable. For example, a removable hard drive may be used for persistent storage 408. Communications unit 410, in these examples, provides for communications with other data processing systems or devices. In these examples, communications unit 410 is a network interface card. Communications unit 410 may provide communications through the use of either or both physical and wireless communications links.

Input/output (I/O) unit 412 allows for input and output of data with other devices that may be connected to data processing system 400. For example, input/output (I/O) unit 412 may provide a connection for user input through a keyboard, a mouse, and/or some other suitable input device. Further, input/output (I/O) unit 412 may send output to a printer. Display 414 provides a mechanism to display information to a user.

Instructions for the operating system, applications, and/or programs may be located in storage devices 416, which are in communication with processor unit 404 through communications framework 402. In these illustrative examples, the instructions are in a functional form on persistent storage 408. These instructions may be loaded into memory 406 for execution by processor unit 404. The processes of the different embodiments may be performed by processor unit 404 using computer-implemented instructions, which may be located in a memory, such as memory 406.

These instructions are referred to as program instructions, program code, computer usable program code, or computer-readable program code that may be read and executed by a processor in processor unit 404. The program code in the different embodiments may be embodied on different physical or computer-readable storage media, such as memory 406 or persistent storage 408.

Program code 418 is located in a functional form on computer-readable media 420 that is selectively removable and may be loaded onto or transferred to data processing system 400 for execution by processor unit 404. Program code 418 and computer-readable media 420 form computer program product 422 in these examples. In one example, computer-readable media 420 may be computer-readable storage media 424 or computer-readable signal media 426.

Computer-readable storage media 424 may include, for example, an optical or magnetic disk that is inserted or placed into a drive or other device that is part of persistent storage 408 for transfer onto a storage device, such as a hard drive, that is part of persistent storage 408. Computer-readable storage media 424 also may take the form of a persistent storage, such as a hard drive, a thumb drive, or a flash memory, that is connected to data processing system 400. In some instances, computer-readable storage media 424 may not be removable from data processing system 400.

In these examples, computer-readable storage media 424 is a physical or tangible storage device used to store program code 418 rather than a medium that propagates or transmits program code 418. Computer-readable storage media 424 is also referred to as a computer-readable tangible storage device or a computer-readable physical storage device. In other words, computer-readable storage media 424 is non-transitory.

Alternatively, program code 418 may be transferred to data processing system 400 using computer-readable signal media 426. Computer-readable signal media 426 may be, for example, a propagated data signal containing program code 418. For example, computer-readable signal media 426 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 418 may be downloaded over a network to persistent storage 408 from another device or data processing system through computer-readable signal media 426 for use within data processing system 400. For instance, program code stored in a computer-readable storage medium in a server data processing system may be downloaded over a network from the server to data processing system 400. The data processing system providing program code 418 may be a server computer, a client computer, or some other device capable of storing and transmitting program code 418.

The different components illustrated for data processing system 400 are not meant to provide architectural limitations to the manner in which different embodiments may be implemented. The different illustrative embodiments may be implemented in a data processing system including components in addition to and/or in place of those illustrated for data processing system 400. Other components shown in Fig. YY can be varied from the illustrative examples shown. The different embodiments may be implemented using any hardware device or system capable of running program code. As one example, data processing system 400 may include organic components integrated with inorganic components and/or may be comprised entirely of organic components excluding a human being. For example, a storage device may be comprised of an organic semiconductor.

In another illustrative example, processor unit 404 may take the form of a hardware unit that has circuits that are manufactured or configured for a particular use. This type of hardware may perform operations without needing program code to be loaded into a memory from a storage device to be configured to perform the operations.

For example, when processor unit 404 takes the form of a hardware unit, processor unit 404 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a field programmable logic array, a field programmable gate array, and other suitable hardware devices. With this type of implementation, program code 418 may be omitted, because the processes for the different embodiments are implemented in a hardware unit.

In still another illustrative example, processor unit 404 may be implemented using a combination of processors found in computers and hardware units. Processor unit 404 may have a number of hardware units and a number of processors that are configured to run program code 418. With this depicted example, some of the processes may be implemented in the number of hardware units, while other processes may be implemented in the number of processors.

In another example, a bus system may be used to implement communications framework 402 and may be comprised of one or more buses, such as a system bus or an input/output bus. Of course, the bus system may be implemented using any suitable type of architecture that provides for a transfer of data between different components or devices attached to the bus system.

Additionally, communications unit 410 may include a number of devices that transmit data, receive data, or both transmit and receive data. Communications unit 410 may be, for example, a modem or a network adapter, two network adapters, or some combination thereof. Further, a memory may be, for example, memory 406, or a cache, such as that found in an interface and memory controller hub that may be present in communications framework 402.

The flowcharts and block diagrams described herein illustrate the architecture, functionality, and operation of possible implementations of systems, methods, and computer program products according to various illustrative embodiments. In this regard, each block in the flowcharts or block diagrams may represent a module, segment, or portion of code, which comprises one or more executable instructions for implementing the specified logical function or functions. It should also be noted that, in some alternative implementations, the functions noted in a block may occur out of the order noted in the drawings. For example, the functions of two blocks shown in succession may be executed substantially concurrently, or the functions of the blocks may sometimes be executed in the reverse order, depending upon the functionality involved.

### Example 4

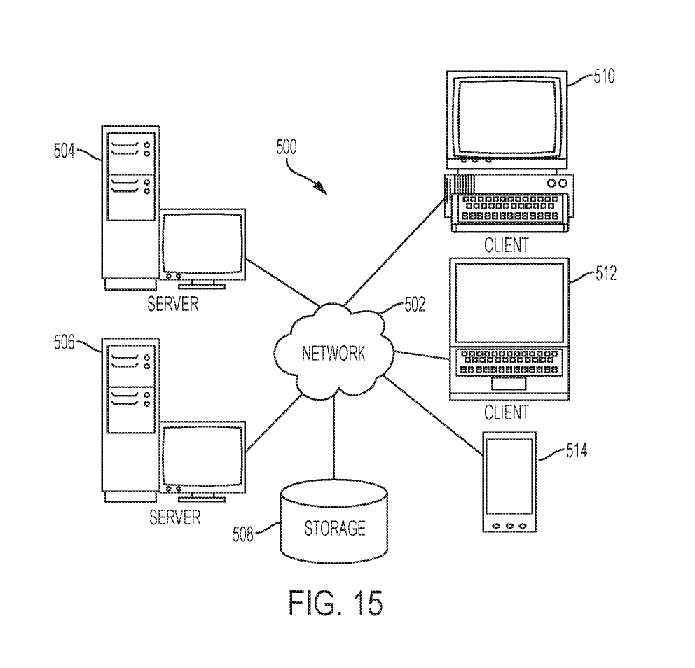

As shown in FIG. 15, this example describes a general network data processing system 500, interchangeably termed a network, a computer network, a network system, or a distributed network, aspects of which may be included in one or more illustrative embodiments of a money calendar system. For example, a method of analyzing stock price data to find seasonal effects may be performed by a processing device in communication with a server having historic stock price data, the communication taking place over a network. It should be appreciated that FIG. 15 is provided as an illustration of one implementation and is not intended to imply any limitation with regard to environments in which different embodiments may be implemented. Many modifications to the depicted environment may be made.

Network data processing system 500 is a network of computers, each of which is an example of data processing system 400, and other components. Network data processing system 500 may include network 502, which is a medium configured to provide communications links between various devices and computers connected together within network data processing system 500. Network 502 may include connections such as wired or wireless communication links, fiber optic cables, and/or any other suitable medium for transmitting and/or communicating data between network devices, or any combination thereof.

In the depicted example, a first network device 504 and a second network device 506 connect to network 502, as does an electronic storage device 508. Network devices 504 and 506 are each examples of data processing system 400, described above. In the depicted example, devices 504 and 506 are shown as server computers. However, network devices may include, without limitation, one or more personal computers, mobile computing devices such as personal digital assistants (PDAs), tablets, and smart phones, handheld gaming devices, wearable devices, tablet computers, routers, switches, voice gates, servers, electronic storage devices, imaging devices, and/or other networked-enabled tools that may perform a mechanical or other function. These network devices may be interconnected through wired, wireless, optical, and other appropriate communication links.

In addition, client electronic devices, such as a client computer 510, a client laptop or tablet 512, and/or a client smart device 514, may connect to network 502. Each of these devices is an example of data processing system 400, described above regarding FIG. 14. Client electronic devices 510, 512, and 514 may include, for example, one or more personal computers, network computers, and/or mobile computing devices such as personal digital assistants (PDAs), smart phones, handheld gaming devices, wearable devices, and/or tablet computers, and the like. In the depicted example, server 504 provides information, such as boot files, operating system images, and applications to one or more of client electronic devices 510, 512, and 514. Client electronic devices 510, 512, and 514 may be referred to as “clients” with respect to a server such as server computer 504. Network data processing system 500 may include more or fewer servers and clients or no servers or clients, as well as other devices not shown.

Client smart device 514 may include any suitable portable electronic device capable of wireless communications and execution of software, such as a smartphone or a tablet. Generally speaking, the term “smartphone” may describe any suitable portable electronic device having more advanced computing ability and network connectivity than a typical mobile phone. In addition to making phone calls (e.g., over a cellular network), smartphones may be capable of sending and receiving emails, texts, and multimedia messages, accessing the Internet, and/or functioning as a web browser. Smart devices (e.g., smartphones) may also include features of other known electronic devices, such as a media player, personal digital assistant, digital camera, video camera, and/or global positioning system. Smart devices (e.g., smartphones) may be capable of connecting with other smart devices, computers, or electronic devices wirelessly, such as through near field communications (NFC), BLUETOOTH®, Wi-Fi, or mobile broadband networks. Wireless connectively may be established among smart devices, smartphones, computers, and other devices to form a mobile network where information can be exchanged.

Program code located in system 500 may be stored in or on a computer recordable storage medium, such as persistent storage 408 in Example 3, and may be downloaded to a data processing system or other device for use. For example, program code may be stored on a computer recordable storage medium on server computer 504 and downloaded for use to client 510 over network 502 for use on client 510.

Network data processing system 500 may be implemented as one or more of a number of different types of networks. For example, system 500 may include an intranet, a local area network (LAN), a wide area network (WAN), or a personal area network (PAN). In some examples, network data processing system 500 includes the Internet, with network 502 representing a worldwide collection of networks and gateways that use the transmission control protocol/Internet protocol (TCP/IP) suite of protocols to communicate with one another. At the heart of the Internet is a backbone of high-speed data communication lines between major nodes or host computers. Thousands of commercial, governmental, educational and other computer systems may be utilized to route data and messages. FIG. 15 is intended as an example, and not as an architectural limitation for any illustrative embodiments.

### Advantages, Features, Benefits

The different embodiments of the money calendar system described herein provide several advantages over known solutions for identifying and displaying seasonal effects and patterns in historic stock price data. For example, the illustrative embodiments of a money calendar system described herein allow a user to identify a seasonal effect in a stock by looking at an appropriate display of simulated historic profitable trades on a Gantt-style chart. Additionally, and among other benefits, illustrative embodiments of the money calendar systems described herein allow a user the freedom to identify newly emerging seasonal effects in a stock price. No known system or device can perform these functions. Thus, the illustrative embodiments described herein are particularly useful for investors interested in identifying seasonal effects in a stock. However, not all embodiments described herein provide the same advantages or the same degree of advantage.

### Conclusion

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only, and do not constitute a characterization of any claimed invention. The subject matter of the invention(s) includes all novel and nonobvious combinations and subcombinations of the various elements, features, functions, and/or properties disclosed herein. The following claims particularly point out certain combinations and subcombinations regarded as novel and nonobvious. Invention(s) embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the invention(s) of the present disclosure.

What is claimed is:

1. A method of displaying seasonal effects in historic stock price data using a processing device, the method comprising:
receiving, with the processing device, information sufficient to identify a stock;
retrieving, with the processing device, historical pricing information for the stock;
constructing, with the processing device, a plurality of historic hypothetical trades of the stock including a plurality of common-day trades, with each common-day trade containing a number of individual trades, each individual trade occurring during a previous year of a predetermined number of previous years and each individual trade within a common-day trade characterized by: (a) a common start business day of the year within a start range of business days, (b) a common end business day of the year a predetermined number of business days after the common start business day, and (c) a common designation as either a long trade or a short trade;
based on the historical pricing information for the stock, determining, with the processing device for each of the plurality of common-day trades, a number of profitable individual trades within each common-day trade, wherein each of the profitable individual trades would have yielded a profit had it been made;
for each common-day trade, creating, with the processing device, an entry on a list of profitable common-day trades if a ratio of the number of profitable individual trades within a common-day trade to the predetermined number of previous years is above a specified accuracy threshold, the entry including (a) the common start business day of the year for the individual trades within the common-day trade, (b) the common end business day of the year for the individual trades within the common-day trade, and (c) the common designation of the individual trades within the common-day trade as either a long trade or a short trade; and
generating, with the processing device, a display of profitable trades including a graphical display bar for every entry on the list of profitable common-day trades, each bar having (a) a first end disposed on the display to indicate the common start business day of the year for the individual trades within the common-day trade, (b) a second end disposed on the display to indicate the common end business day of the year for the individual trades within the common-day trade, and (c) a non-alphanumeric visual indication of the common designation of the individual trades within the common-day trade as either a long trade or a short trade.

2. The method of claim 1, wherein the step of generating a display includes generating the graphical display bars in descending order based on the ratio of the number of profitable individual trades within a common-day trade to the predetermined number of previous years for the profitable common-day trades.

3. The method of claim 1, wherein the step of generating a display includes generating each graphical bar in a first color if the common designation of the individual trades within the corresponding common-day trade is a long trade, and in a second color if the common designation of the individual trades within the corresponding common-day trade is a short trade.

4. The method of claim 1, wherein each graphical display bar is characterized by a primary segment length and a secondary segment length contained within the primary segment length, such that a ratio of the secondary segment length to the primary segment length indicates the ratio of the number of profitable individual trades within a common-day trade to the predetermined number of previous years for the profitable common-day trades.

5. The method of claim 4, wherein the secondary segment length is displayed in a first color and a portion of the primary segment length that does not include the secondary segment length is displayed in a second color.

6. A method of displaying patterns in historic stock price data using a processing device, the method comprising:
receiving, at the processing device, information sufficient to identify a stock;
receiving, at the processing device, historical pricing information for the stock;
simulating, with the processing device, a plurality of historic hypothetical common-day trades for the stock, each common-day trade including a number of individual trades, each individual trade occurring during a particular previous year chosen from a predetermined number of previous years, and each individual trade characterized by: (a) a common start business day of the year within a start range of business days, (b) a common end business day occurring a predetermined number of business days after the common start business day, and (c) a common designation as either a long trade or a short trade;
based on the historical pricing information for the stock, determining, with the processing device, for each of the plurality of common-day trades, a number of profitable individual trades within each common-day trade, wherein each of the profitable individual trades would have yielded a profit had it been made;
determining, with the processing device, for each of the plurality of common-day trades, a ratio of the number of profitable individual trades to the predetermined number of previous years;
for each common-day trade for which the ratio of the number of profitable individual trades to the predetermined number of previous years is above a threshold ratio, displaying, on a graphical user interface, a graphical representation of the profitable common-day trades, the graphical representation including a graphical bar representing each profitable common-day trade, wherein for each graphical bar:
(a) a first end of the graphical bar represents the common start business day of the year for the individual trades within the common-day trade, and
(b) a second end of the bar represents the common end business day of the year for the individual trades within the common-day trade.

7. The method of claim 6, further comprising displaying, on the graphical user interface, for each common-day trade for which the ratio of the number of profitable individual trades to the predetermined number of previous years is above the threshold ratio, a non-alphanumeric visual indication of the common designation of the individual trades within the common-day trade as either a long trade or a short trade.

8. The method of claim 7, wherein the non-alphanumeric visual indication includes displaying the graphical bar as a first color if the individual trades within the common-day trade are commonly designated as long trades, and displaying the graphical bar as a second color if the individual trades within the common-day trade are commonly designated as short trades.

9. The method of claim 6, further comprising receiving, at the processing device, a user-selected value of the predetermined number of business days after the common start business day that the common end business day occurs.

10. The method of claim 6, wherein the predetermined number of business days falls in the range of one to thirty days.

11. The method of claim 6, wherein the predetermined number of business days falls in the range of one to ten days.

12. The method of claim 6, further comprising receiving, at the processing device, a user-selected value of the start range of business days.

13. A method of displaying patterns in historic stock price data on a graphical user interface, the method comprising:
simulating, with a processing device, a plurality of sets of simulated trades for a stock, each set including a plurality of simulated trades, each trade within a set starting on a common start date during a different past calendar year and extending for a common duration between simulated purchase and sale of the stock;
based on historical pricing information for the stock, determining, with the processing device, a profit or loss that would have occurred if the simulated trade had been made;
determining, with the processing device, a fraction of simulated trades within each set of simulated trades that would have yielded a profit if the simulated trades had been made; and
displaying, on a graphical user interface, a graphical representation of each set of simulated trades for which the fraction of simulated trades that would have yielded a profit exceeds a predetermined minimum fraction, the graphical representation including a representation of the common start date and common duration corresponding to each set of simulated trades.

14. The method of claim 13, wherein the graphical representation includes a graphical bar having a first end representing the common start date of the simulated trades of the set, and a primary segment length representing the common duration of the simulated trades of the set.

15. The method of claim 14, wherein the step of displaying includes displaying the graphical bars in an order based on the fraction of simulated trades within each graphically represented set of simulated trades that would have yielded a profit if the simulated trades had been made.

16. The method of claim 14, wherein the step of displaying includes displaying each graphical bar in a first color if each of the simulated trades of a set has a common designation as a long trade, and in a second color if each of the simulated trades of a set has a common designation as a short trade.

17. The method of claim 14, wherein the graphical bar further has a secondary segment length contained within the primary segment length such that a ratio of the secondary segment length to the primary segment length indicates the fraction of simulated trades that would have yielded a profit.

18. The method of claim 17, wherein the secondary segment length is displaying in a first color and a portion of the primary segment length that does not include the secondary segment length is displayed in a second color.

19. The method of claim 14, wherein the common duration is between one and thirty days for each set of simulated trades.

20. The method of claim 14, wherein the step of displaying includes displaying the graphical representation of the sets in an order based on the average profit that would have been obtained if the simulated trades of the corresponding set had been made.
